(19) United States
(12) Patent Application Publication
(10) Pub. No.: US 2026/0330905 A1
(43) Pub. Date: Oct. 22, 2026

(54) SYSTEMS, APPARATUS, AND METHODS FOR STATE-BASED ACCESS RESOLUTION

(71) Applicant: Durin, Inc., Sunnyvale, CA (US)

(72) Inventors: Ayse Beril Altiner, Hinsdale, IL (US); Herman Yau, Sunnyvale, CA (US); Frederik Delacourt, Celina, TX (US)

(73) Assignee: Durin, Inc., Sunnyvale, CA (US)

(21) Appl. No.: 19/529,004

(22) Filed: Feb. 3, 2026

Related U.S. Application Data
(60) Provisional application No. 63/753,435, filed on Feb. 3, 2025.

(51) Int. Cl. G07C 9/00; G06V 20/52

(52) U.S. Cl. CPC G07C 9/00904; G06V 20/52; G07C 9/00563

(57) ABSTRACT

Systems, apparatus, and methods for state-based access resolution. In one aspect, states define conditions and the corresponding reaction for an access event. State-based access resolution may trigger locking/unlocking based on arrival and departure conditions. In another aspect, multiple states of nodes are used to generate system states; system-wide states allow e.g., context-based locks to coordinate behavior based on information from other context-based locks, etc. In yet another aspect, state-based access resolution enables sequential behavior beyond locking and unlocking (e.g., continuing alerts, notifications, panic room functionality, etc.).

### PRIORITY

This application claims the benefit of priority to U.S. Provisional Patent Application Ser. No. 63/753,435 filed Feb. 3, 2025, and entitled “SYSTEMS, APPARATUS, AND METHODS FOR STATE-BASED ACCESS RESOLUTION”, which is incorporated by reference in its entirety.

### RELATED

This application is related to U.S. patent application Ser. No. 19/171,017 filed Apr. 4, 2025, and entitled “SYSTEMS, APPARATUS, AND METHODS FOR ACCESS RESOLUTION BASED ON SITUATIONAL AWARENESS”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of physical access control and building security. The disclosure is primarily discussed in reference to residential applications, but the techniques have broad applicability to commercial applications as well.

### DESCRIPTION OF RELATED TECHNOLOGY

In recent years, “smart” locks have become increasingly popular. Smart locks can be controlled remotely via smartphones or other devices, allowing home owners to monitor and manage access to their properties more conveniently. Typically, these devices are designed to be installed at the entrance of a home or building, allowing users to see and communicate with visitors remotely through a smartphone app. When someone rings the doorbell or triggers the motion sensors, the camera activates, sending live video and audio to the user's device.

Most smart locks use e.g., user input, user device proxy input, or schedule-based behaviors. User input implementations often require a user to touch/push a designated button on the smart lock to explicitly signal intent. The lock then actuates the mechanical locking mechanism. Alternative solutions may use a device as a proxy for the user; for example, a smart phone can use RF signal strength and/or geofencing to detect when the user travels beyond a predefined zone, this triggers actuation of the lock. Schedule-based locking allows the user to define a schedule (via a smart lock app) to schedule automatic locking conditions e.g., an unlocked door may wait a duration before automatically locking.

### BRIEF DESCRIPTION OF THE DRAWINGS

FIG. 1 is a logical block diagram of a physical access resolution system, in accordance with various aspects of the present disclosure.

FIG. 2 is a graphical representation of a multi-staged pipeline with different proximity zones, useful to illustrate the operation of the physical access resolution system.

FIG. 3 is a logical representation of a residence, useful to illustrate the operation of the physical access resolution system.

FIG. 4 is a logical representation of a state machine representative of selected scenarios for “walk-up, walk-in” operation described herein.

FIG. 4 is a logical representation of a state machine representative of selected scenarios for system-wide situational information described herein.

FIG. 6 is a graphical representation of one residence useful to illustrate various system-wide aspects of the present disclosure.

FIG. 7 is a logical block diagram of one system for access resolution based on situational awareness, useful in accordance with various aspects of the present disclosure.

FIG. 8 is a logical block diagram of a physical access resolution device 800.

FIG. 9 is a logical block diagram of system administration logic 900.

FIG. 10 is a logical block diagram illustrating information distribution within the physical access resolution system.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Access Events and Situational Information

Conventional smart lock solutions inherit many of the design assumptions of mechanical locks-such devices are primarily focused on automating lock/unlock based on a proxy key or other user input. This basic framework has a variety of limitations. For example, user input-based solutions place cognitive and/or physical burden on the user; e.g., the user must remember to act and perform the correct operation to achieve the desired outcome. This may be difficult for users that have atypical needs (e.g., elderly, children, individuals with disabilities, etc.).

Proxy solutions substitute device action for user action—this may introduce other issues. For example, a user may be required to carry a user device (e.g., a phone, key fob, etc.). Depending on sensor precision, the user device may e.g., be unable to determine its exact position which can interfere with operation. Overly zealous logic may result in undesirable churn (locking/unlocking), whereas conservative logic may introduce “dead zones” e.g., situations where the lock is left open even though the user has left the premises.

Some solutions leverage patterns of use and/or other historic information to schedule locking/unlocking. These schedule-based solutions may result in accidental lock-outs. In other words, a door that automatically locks after timer expiration may lock-out a user without their device.

Various aspects of the present disclosure are directed to “walk-up, walk-in” doors and/or locks (context-based doors and/or locks). “Walk-up, walk-in” devices resolve access based on situational awareness. The device infers the current situation by collecting and analyzing contextual cues and information. The inferred situation may be associated with a degree of certainty/uncertainty (confidence); in some cases, context-based locks may further refine/update its situational assessment based on additional contextual cues gathered post-access.

In one specific implementation, a context-based door includes internal and external sensors to observe and understand the context of an access event. For example, the sensors may include two or more cameras that have a “360° view” (both sides of the door) to collect information leading up to, during, and/or after the access event. In some cases, a context-based system may collect information from multiple sensors to e.g., control access, monitor activity, infer user occupancy, etc. For example, a house with multiple context-based doors and/or interior cameras may internally monitor ingress/egress and occupancy.

Here, contextual cues may include e.g., biometric data (e.g., face recognition, voice recognition, fingerprint, retinal print, etc.), device data (e.g., personal devices such as smart phones, smart watches, smart glasses, etc.), usage patterns, and/or environmental signals (time of day/night, weather, etc.)). More broadly, contextual cues may include any information used to assess the access event; this may include e.g., sensed information, inferred information, derived information, and/or user input. For example, a user may be unable to manually enter their passcode/fingerprint if they are carrying groceries, wearing heavy mittens, etc. As another such example, a user might be forced to give a passcode under duress (or a “duress code word”)—this may permit access but also silently notify law enforcement and/or emergency services that the user is under duress. In some cases, access may be permitted even without normal authentication (e.g., elderly, children, and/or pets, etc.). Contextual clues can be used to proactively identify the user and the circumstances surrounding an access event in real-time, potentially reducing and/or eliminating manual authentication processes.

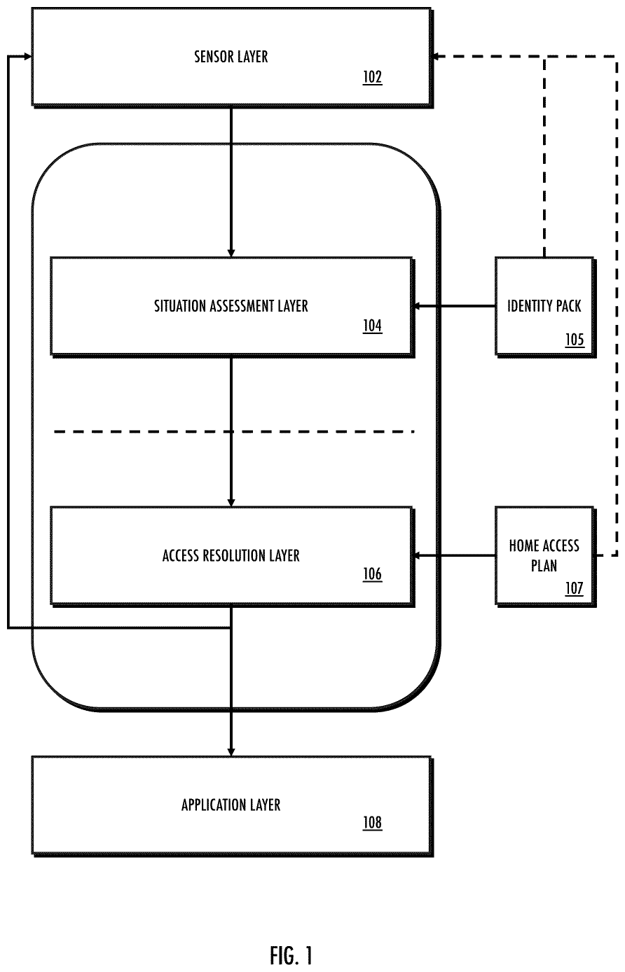

Consider the physical access resolution system of FIG. 1, that includes e.g., a sensor layer 102, an assessment layer 104, a resolution layer 106, and an application layer 108.

Each layer “abstracts” its data and operation from other layers—only the overarching functionality of the layer is presented to other layers (e.g., via an application programming interface (API), etc.). The layered architecture enables interoperation between multiple different subsystems—for example, the assessment layer 104 may access multiple different sensors from the sensor layer 102. Similarly, a resolution layer 106 may generate resolutions that are used by different applications 108. The layered architecture allows the system to flexibly incorporate components (including 3^{rd} party solutions) to address a wide variety of needs. Additionally, the layered architecture allows for task scheduling of multiple concurrent distinct tasks—this may be particularly useful where e.g., multiple different resolutions are needed to address a situation, etc.

More generally, abstraction may be used to coordinate the functional components of physical access resolution with 3^{rd} party/after-market components and/or other desirable high-level functionality. An API-based interface may allow the sensor layer to incorporate a broad selection of sensor technologies. 3^{rd} party sensors may include legacy sensors as well as future sensor technologies. Similarly, an API-based application layer may enable e.g., home automation software, provide remote access, and/or enable other modern networked and machine-based applications.

During operation, the physical access resolution system of FIG. 1 uses multi-modal sensing to monitor and detect for approaching subjects (animal, person, machine, etc.) at an access point (e.g., a doorway or other entry point). As the subject approaches, the system will actively use its sensor layer 102 (e.g., an array of sensors having multiple different modalities) to detect and assess the situation, prior to an access event (pre-access). In some variants, the sensor layer 102 may also passively capture unique identifiers used by the system. These data structures may be defined by an administrator in identity pack data structures 105 and/or home access plan data structures 107, discussed in greater detail below.

The sensor layer 102 provides its sensed data to the situation assessment layer 104, this layer processes the sensed data and predicts the identity of the subject(s) using the identity pack data structures 105. In one specific implementation, each identity pack data structure is specific to a single registered user. Here, the subject may be identified as a “known” person (a registered user, or “member”), an “unknown” person (an unregistered user, or “non-member”), and/or “other” entity (e.g., an animal, machine, etc.).

These categories may have further subcategories; for example, members may have unrestricted members and one or more classes of restricted members. Certain members may be allowed to exit at will, but require authorization to enter e.g., scheduled in-home service and/or in-home delivery. Other members may be allowed to enter at will, but may require authorization to leave (e.g., kids, elderly residents with dementia and/or other cognitive issues, etc.). Non-members may also be subcategorized—by default, most passer-by non-members may be ignored, however more stringent scrutiny may be needed for potentially malicious parties. A victim of domestic abuse may identify their abuser as a potentially malicious non-member; a celebrity may want repeating non-members to be identified as potential stalkers, etc

The situation assessment layer 104 may use a confidence-based (non-binary) situation assessment. As used herein, a “session” refers to one or more “challenges” (a sense-assess-resolve path). Instead of a binary decision, each challenge accumulates more confidence—the accumulated confidence is used to trigger resolutions at the access resolution layer 106. The access resolution layer 106 will take the output of the situation assessment layer 104 and adopt one or more resolutions based on the pre-defined home access plan. Resolutions might grant access, deny access, issue additional authentication challenges, etc. Here, “access” refers to both ingress (entry) and egress (exit) situations.

Confidence-based assessment allows the system to assess a much wider range of potential scenarios. For example, the default access challenge path might be based on computer-vision facial recognition and voice-biometrics with a secret word. If the access subject speaks the right secret word, and matches the pre-registered faceprint and voiceprint, the system may grant access to the user. Additional challenges may be used where the faceprint and/or voiceprint are non-determinative; e.g., a timely generated secret word may be transmitted to the user's phone for the user to speak.

The situation assessment layer may assess a variety of context cues beyond identity. Situational information may include e.g., occupancy, zones of activity, activity type, intent, and/or likely future behavior. For example, access and/or post-access handling may be different when the subject is a single person versus a group of people. Factors may include mental and/or emotional state (e.g., where the subject is inebriated, incapacitated, and/or under duress, etc.), physical state (e.g., injured, handicapped, holding objects, etc.), and/or environmental conditions (e.g., time of day, weather, presence of others, etc.).

During assessment, a first level of confidence may trigger a first resolution (log access attempt), a second level of confidence may trigger a second resolution (grant access). Here, the first confidence level may be relatively low e.g., below 50%; this may conservatively ensure that any approach and/or access attempt is logged while still filtering out undesired noise (e.g., passerbys, etc.). However, an access attempt that exceeds the second confidence level (e.g., 75%) may grant access (e.g., walk-up, walk-in access). In some cases, indeterminate confidence (e.g., 50-75%, etc.) may trigger additional layers of scrutiny.

Importantly, confidence-based assessment may provide potentially much more nuanced handling than grant or denial of access. For example, less confident assessments may trigger multiple additional stages of authentication (e.g., voice recognition, passcode entry, etc.). Once access is granted/denied, various degrees of additional safeguards may be warranted. As but one such example, a user may be granted access and notified that they are being continually monitored, by the homeowner.

Confidence-based assessment also allows multiple sources of “soft” information to be combined into a “hard” decision. For example, an “ambiguous” level of confidence (e.g., confidence levels that fall in the range of 50%-75%) might trigger additional challenge paths. An extremely confident assessment (e.g., confidence levels above 90%) may allow the system to “relax” and transition to quiescent state (a low power mode).

While the foregoing discussion describes a percentage-based confidence for multi-factor authentications, binary multi-factor authentication or even non-multi-factor authentication may be substituted with equal success. A non-MFA implementation might detect the presence of a device (binary present/absent), and unlock if a matching member is found in the identity pack (binary match/no-match). A binary MFA implementation might detect the presence of a device (binary present/absent), and combine with a face recognition (binary recognized/not-recognized) in the identity pack; an unlock only occurs if both factors are met (present and recognized). More generally, any number of multi-factor variants might be used by the home owner to verify identity and grant/deny access.

Here, a challenge path is a structured sequence of security responses (e.g., authentication steps) that dynamically defines when to escalate (e.g., from password to biometrics) or de-escalate (e.g., from multi-factor to single-factor) based on situation. A session might have multiple concurrent and/or sequential challenge paths—not just a single sense-assess-resolve path. Multiple challenge paths leverages less intrusive techniques-like adaptive authentication or contextual checks-so that their strategic combination (rather than brute-force stacking) delivers sufficient security resilience: reliability (consistent operation), robustness (resilience to failures), and security (threat prevention) without overwhelming users or systems.

In one specific implementation, the challenge paths are based on identity packs. An identity pack functions as a flexible, user-configurable security framework that dynamically aggregates contextual metrics—such as biometric signals (e.g., facial recognition), device proximity (e.g., smartphone or wearable proximity), and historical usage patterns (e.g., time of day, access frequency, or location history)—into a single, weighted repository. The home owner may adjust the importance of each factor (e.g., assigning 40% weight to biometrics, 40% to device proximity, and 20% to usage patterns) to balance security and convenience. This customization allows individuals to prioritize their needs: a user seeking faster access might reduce biometric weight to 30% and increase device proximity weight to 50%, while a security-focused user could set biometrics at 50% and usage patterns at 10%.

Multi-factor authentication may be configured at any level of the system. Some implementations may configure multi-factor authentication (MFA) at the top-level (residence). Top-level definitions may ensure that each entity of the system uses a consistent MFA protocol. Other implementations may allow different buildings and/or even individual devices to set their own MFA requirements. For example, a home owner may want to impose different MFA weighting at the house (more valuables, more robust) versus the shed (fewer valuables, more convenience). Other schemes may adjust MFA protocols based on e.g., members, thresholds, zones, time of day, etc.

The system calculates a continuous confidence score (not a binary “yes/no” decision) by statistically combining these weighted factors. This approach eliminates manual authentication steps while enabling proactive authorization: the lock automatically determines if a user is authorized based on real-time contextual evidence-without requiring the user to intervene. By dynamically adapting security intensity through user-defined weights, the identity pack ensures that authorization decisions remain both secure and intuitive, eliminating friction while maintaining robustness.

To illustrate this, consider a “walk-up, walk-in” scenario: a user returns home with groceries, holding a shopping bag. The sensor array detects facial recognition (biometric), proximity to a paired smartphone (device), and historical patterns indicating grocery shopping (usage pattern). Each factor alone would be insufficient to authenticate the user, however in combination, these factors have a relatively high confidence score that exceeds the unlock threshold. The door can automatically unlock without requiring the user to set down groceries to enter a passcode.

In contrast, a person wearing a face mask that obscures their face but has a paired smartphone could be the home owner, or they might be a thief attempting to gain access using a stolen device. The device identifier alone is not enough to authenticate the user, so, in order to disambiguate the situation, the person may be required to speak a password (voice recognition), take off their face mask, etc.

There may be special challenge paths that have been defined by the administrator. For example, a “neighborhood safe home” might configure the system to allow any child from the neighborhood into the house (even if they do not know the secret word) so long as the home owner is present. As another example, a caretaker of a patient with dementia or other cognitive impairment may not allow the patient to leave, even if they correctly use their passcode. A person may have a “duress code” which allows them to gain entry but also trigger a silent alarm for help. Still other applications may include in-house delivery—e.g., a package delivery may be allowed entry to securely deliver packages inside the house but trigger immediate security response for unpermitted actions.

Once resolved, the application layer 108 may expose certain information to 3^{rd} party applications to e.g., monitor, record, and/or otherwise interact with the physical access resolution system data. Importantly, the application layer 108 provides a layer of abstraction from other systems; thus, external parties do not have direct access to raw data (which is likely sensitive).

As previously alluded to, abstraction exposes an external data interface, but hides the underlying implementation of data processing. Abstraction allows software to “black box” functionality, which is important for modularity, reliability, and security. In contrast, integration tightly couples data and processing between entities-integration often allows privileged access into the data path and control path operations. In some cases, integration may leverage specialized hardware-based data sharing mechanisms (e.g., semaphore-based read-write protections, etc.) and/or hardware-based acceleration. Integration often can be used to optimize performance and/or minimize reliance on peripheral and/or network resources. Conceptually, abstraction and/or integration are two different design principles that may be used to trade-off benefits.

While the foregoing architecture is described with abstraction layers, certain implementations may benefit from integration. For example, integration may be used to ensure that the situation assessment layer and/or access resolution layer can transfer context for looping processing. Integration may also be useful for localized device processing. In other words, the physical access resolution system can operate without any network access or external device dependencies. This can increase detection accuracy and reduce latency (e.g., faster interventions, etc.). More directly, unlike conventional systems that generally require significant information technology (IT) infrastructure to provide the same functionality, integration may enable a discrete single point solution for both prevention and intervention.

Artisans of ordinary skill in the related arts will readily appreciate that the foregoing system architecture is purely illustrative, and that other implementations may combine, subdivide, add, remove, or otherwise modify the functionalities described above into any layered implementation with equal success.

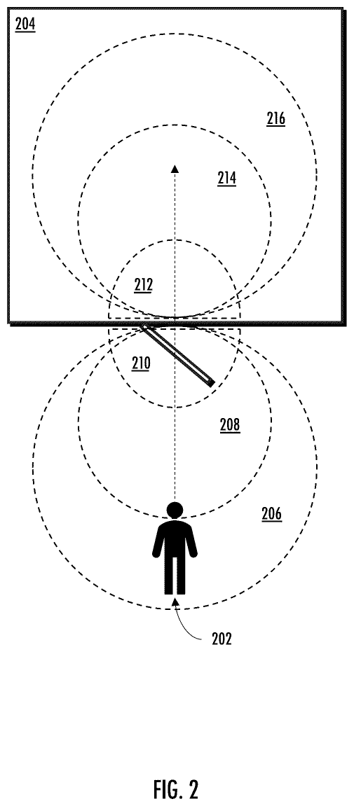

FIG. 2 presents a multi-staged pipeline with different proximity zones, useful to illustrate the operation of the physical access resolution system. While the following discussion is presented in the context of an ingress scenario, the multi-stage pipeline may be broadly extended to egress scenarios as well. For example, ingress may use zone 206 to wake from idle, zone 208 to capture pre-access activity, and/or zone 210 for access resolution; egress scenarios may use zone 216 to wake from idle, zone 214 to capture pre-access activity, and/or zone 212 for access resolution.

During the first stage of operation, the system is idle until activity is detected. In this example, a passive infrared (PIR) motion sensor senses changes in temperature at a specified distance (zone 206 e.g., 10 meters). the PIR motion sensor only collects thermal changes. When a subject 202 approaches the house 204, thermal activity within zone 206 triggers an ultrasonic time-of-flight (ToF) sensor to detect object motion and accurately track the distance of the object. If the object continues to approach the house and breaks the next defined threshold (zone 208 e.g., 7 meters), a second stage of processing (“pre-access”) is triggered. Notably, neither the PIR motion sensor nor the ultrasonic ToF sensor collect any personally identifying information.

The second stage of processing captures pre-access activity. Here, RF sensors, 2D image sensors, and microphones are activated to start capturing uniqueness identifiers within zone 208. A first level of personally identifiable information is collected and used to prepare for an imminent access attempt. Depending on configuration, this preliminary information may be discarded if unused, discarded after review, discarded after a period of time, etc. Once the subject 202 approaches the doorway (zone 3 210, within 3 meters) the third stage of processing (“access”) is triggered.

In zone 210, the third stage of processing performs access resolution (e.g., the “access granting zone”). Here the system captures access activity and collects a second (higher) level of personally identifiable information that is used to authenticate and/or resolve the access attempt (discussed in greater detail below). For example, 3D depth sensors are activated, and facial recognition may be performed. Depending on configuration, the session and its constituent challenges (sense-assess-resolve paths) may be logged; personally identifiable information may be recorded for long term archival.

Privacy is an important consideration; thus, some variants may provide indications and/or notifications of pipeline progress. For example, there may be status indicator lights (audible chimes, etc.) to explicitly inform the approaching subject that different stages of the pipeline are being activated and/or that personally identifying information is being collected. This gives the approaching subject explicit feedback and the option to de-escalate the pipeline by stopping the approach and/or backing away.

As a brief aside, undesirable activity may be perpetrated by both external and internal bad actors; this is broadly applicable to both residential and commercial applications. Having information leading-up-to, during, and following-after the access event (pre-access, access, and post-access) can provide a complete picture for post-mortem incident analysis. While most physical access control systems are focused on prevention (denying access), the exemplary physical access resolution system may also implement intervention countermeasures—i.e., where access has been granted, but a breach in security or access policy happens, and appropriate action needs to be taken to rectify the situation. Examples might include “tailgating” of an unauthorized actor, propping doors and/or interfering with sensors to prevent normal operation, suspicious activity by authorized persons, etc.

In one exemplary embodiment, a fourth stage of processing may continue to capture post-access activity and/or trigger additional resolutions within zones 212 (or even further into the house, if necessary). For example, the cameras that monitor zone 210 and zone 212 may be implemented as high resolution imagers, each with 180° field-of-view (FOV), that can be stitched together to provide a 360° capture of the post-access activity. An integrated solution may stitch and map the images and/or video from both sensors together with door state and orientation data to create an access event data structure. Completely integrated implementations may provide this functionality entirely on-device using the local resources (such that no external network connectivity is required).

The access event data structure may be rendered in a variety of different ways. For example, the access event data structure may be viewed as an image or video, with seamless re-framing from various different perspectives. One visualization might be an “interior threshold view” that uses a consistent orientation lock of the stitched 360° capture to capture video of the subject(s) as they cross the threshold from zone 210 into zone 212. Other implementations may incorporate other sensors and/or processing to provide different visualizations. For example, computer-vision processing with 3D image sensors can create a depth cloud that may be used, in combination with the door's positioning and known location, to re-map the 3D space into a 2D image from any perspective; e.g., a top-down view might be used to provide a “blueprint view” of the access, etc.

During the fourth stage of processing, post-access activity can be monitored and post-access resolution processing may occur in real-time to trigger interventions if necessary. For example, a post-activity access resolution that permits entry one person at a time can be enforced with audible alarms for attempted tailgating. If the tailgater does not comply, then the remedial actions can be taken (e.g., home owner notified, emergency services called, etc.). Similarly, a post-access resolution may require that the door shuts within a certain amount of time after access is granted; propping the doors open may trigger audible alarms of escalating intensity, etc. A parcel delivery person may be allowed to deliver packages within the house threshold, but may not have permission to proceed further; post-activity resolution processing may alert the home owner if the delivery person breaches zone 212, etc. In some variants, the user may get a real-time alert of a delivery and watch the delivery (as a live video stream, animated GIF, etc.)—the user may choose to trigger an intervention resolution if necessary and/or directly communicate with the delivery person.

Importantly, the multi-staged pipeline organizes the access event into multiple phases of activity. Full visibility and context is important for a post-mortem incident analysis of any access attempt (e.g., approach, credentialling, grant, ingress/egress, resecuring the door, and departure), but may also be particularly informative when used to analyze behaviors in aggregate. Categorizations might include patterns of e.g. pre-access activity (approaches, back-offs, etc.), access activity (repeated failures, brute force attempts, etc.), post-access, etc. In some cases, categorization may additionally be based on subject, time-of-day, seasonality, etc. These categories may be reviewed and used to ignore normal routines and/or flag abnormal behavior. For example, pre-access activity reports might identify a subject that repeatedly approaches the house while the home owner is away. On review, the home owner can use categorization to quickly filter out innocuous routines (e.g., mailman, helpful neighbors) from more suspicious activity (e.g., a would-be-thief testing to see if the door is consistently locked, etc.).

The foregoing discussions illustrate the operation of a physical access resolution system for a single physical threshold. However, most buildings have multiple physical thresholds. Furthermore, residences may have multiple buildings.

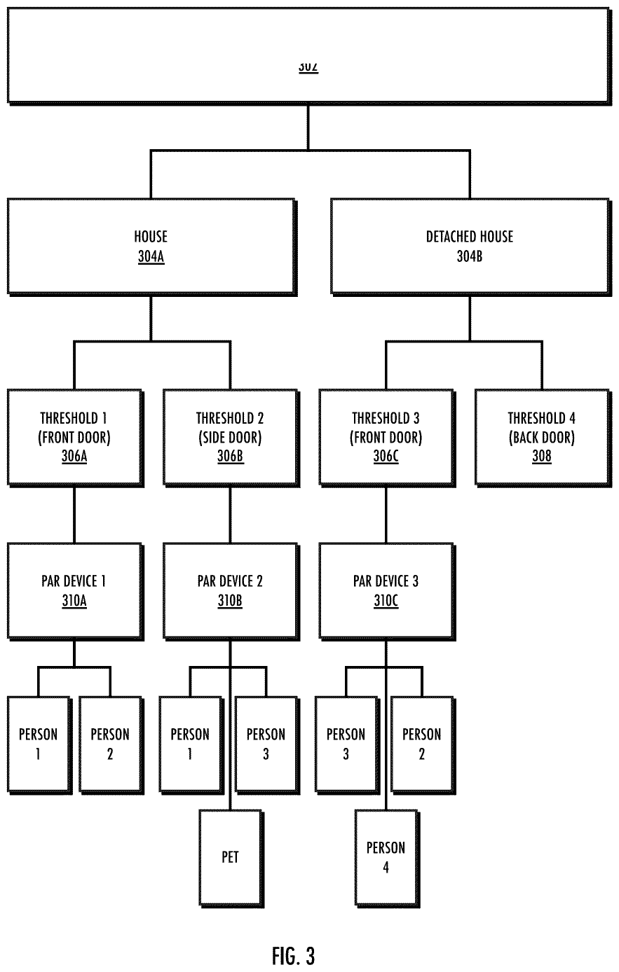

Consider for example, the logical representation of a residence depicted within FIG. 3. The residence 302 has two buildings: a house 304A and a detached structure 304B (e.g., a garage, pool house, shed, etc.). The house 304A has two thresholds: a front door 306A, a side door 306B; the detached structure 304B has two thresholds: a front door 306C and a back door 308. Some of the physical thresholds have a physical access resolution (PAR) device installed (first PAR 310A, second PAR 310B, third PAR 310C); the back door 308 is unmonitored. Each physical access resolution device includes identity pack data structures that correspond to its expected users. For example, the first PAR 310A has identity pack data structures for a first person and a second person; the second PAR 310B has identity pack data structures for the first person and a third person, etc.

A physical access resolution (PAR) device refers to any device that monitors, manages, and administers access resolution according to the techniques described throughout. Notably, while these examples are described in the context of a residential scenario, the concepts are broadly applicable to a variety of applications (e.g., commercial property management, short term rentals, hotel and hospitality, etc.). The concepts may be broadly extended to any building and/or premises with any number of physical thresholds.

While the following discussions describe a PAR that manages a door, artisans of ordinary skill in the related arts may appreciate that some thresholds may have multiple doors. For example, a door might have a screen door, a solid door, and a pet door. The threshold might be considered locked if either or both of the screen door and solid door are locked. Depending on the size of the pet door, the system may or may not require the pet door to also be locked, etc.

Many different people may interact with the residence. Some people may be members (family, friends, guests, pets, etc.), other people may be non-members (passers-by, delivery personnel, walk-up solicitors, etc.). A “member” is a person that is registered to the residence, and has a permissions-based role; examples of roles might include e.g., access administrators, residents, dependents, visitors, service company, service individuals, etc. A “non-member” is a person that does not have any type of current permission/role. Non-members may be further classified according to categories; examples of categories might include e.g., unknown (never before detected), known but unregistered (previously detected in some capacity, but not registered to the residence), unwelcome, and/or ex-members (previous role expired or revoked). One exemplary implementation of roles and their definitions is provided within APPENDIX A.

Members may have an access mechanism that enables the member to enter (and/or exit) the building and/or premises. In one specific embodiment, the access mechanism is an application that verifies and/or validates identity based on e.g., facial recognition, voice commands, schedule information, and/or other identifying characteristics of a user to generate a data structure (referred to as a “multi-factor hybrid key”) that enables access. The application may be executed from a local device (e.g., smartphone, smart watch, etc.) or any other digital entity (remote application, QR code, etc.) to provide a multi-factor hybrid key functionality. In other implementations, the application may be directly incorporated within the context-based lock itself (e.g., access may be enabled by relying on other identifying characteristics, even when the person does not have devices on their person, etc.).

As described elsewhere, multi-factor hybrid key functionality combines multiple factors together when authenticating a user. For example, an identity pack data structure may store observable contextual metrics and their weights at each physical access resolution device. Each factor within the identity pack may be assigned a weight; in some cases different access points may be configured differently according to usage. For example, the door to the garage may allow a pet cat to enter and use the litter box; however, since the cat is an indoor cat, it is not permitted to exit the other doors, etc.

The combination of multiple factors may be based on a confidence level. In other words, instead of a binary decision, each challenge accumulates more confidence—the accumulated confidence is used to authenticate the user. Confidence-based authentication allows the system to assess a much wider range of potential scenarios. For example, the default access challenge path might be based on computer-vision facial recognition and voice-biometrics with a secret word. If the access subject speaks the right secret word(s), and matches the pre-registered faceprint and voiceprint, the system may grant access to the user. Additional challenges may be used where the faceprint and/or voiceprint are non-determinative; e.g., a timely generated secret word may be transmitted to the user's phone for the user to speak.

More broadly, multi-factor hybrid key functionality may be used with any combination of biometric, device-based, and/or behavioral factors. Examples may include, without limitation, voiceprint, spoken passphrase, gait, olfactory signature, schedule information, ownership or other association (e.g., vehicle, pets, etc.), and/or other identifying characteristics of a user.

The conceptual framework of the physical access resolution system described above enables new paradigms for access resolution. As previously noted, most smart locks share the assumptions of conventional mechanical locks—for example, a door may be in either a “locked” or “unlocked” state. Furthermore, mechanical locks only lock or unlock. While some smart locks may have some conditional behavior, these are limited to the context that the smart lock can determine. Conceptually, however, the state of the door is different than the state of the building. An interior zone of the building may not be “secure” unless all of the physical thresholds (doors, windows, etc.) are “locked”. For multi-building residences, the residence may not be secure unless all its buildings are secure.

More generally, the physical access resolution system can consider a system-wide state based on information gathered from many nodes of the system. In addition, the physical access resolution system can continue to act based on system-wide state. Even where access may be granted (or forcibly obtained) at an external door, the system-wide state may take active fallback measures of suitable degree (e.g., determining the occupancy inventory, locking interior doors, notifying the owner and/or authorities, etc.). As but one such example, a multi-building residence may notify a user whenever any of its buildings are unsecured, left ajar, etc.

In addition, situational awareness may also enable the system to correctly interpret what a user is doing, and appropriately react, to provide the illusion of seamless/effortless coordination. For example, a user puttering around a house might be assisted with actuated doors that unlock and/or open as needed. In some cases, situational awareness may also be used to predictively prepare for future user action, offering a nearly prescient user experience. For example, a system may observe that a user has a morning routine of leaving for work, and predictively secure the premises at the appropriate time in the future.

### 2 System-Wide Scenarios (“Flows”)

Various embodiments of the present disclosure handle access events according to a “flow” of processing tasks (e.g., implemented as a state machine). In one specific embodiment, the physical access resolution system prescribes a number of system states; system states correspond to the entire residence and are distinct from node states which correspond to specific thresholds of the residence. The system state may be used to coordinate activity across nodes.

Consider the following scenario, a house may attempt to transition to a secure state when the last member leaves. If the house successfully closes and locks all of its physical thresholds, then it enters the secure state. If, however, any of the nodes cannot transition to its locked state (e.g., a door is propped open, a lock is left unlocked, etc.), then the house transitions to an unsecure state, and notifies at least one member to return and rectify the issue.

As a related example, a node of the system may enter a compromised state (e.g., a burglar forces entry, a door is propped open, etc.). The house may be unable to secure the entire interior of the house, however, it may be able provide a fallback layer of security by locking internal doors to protect selected interior security zones (e.g., bedrooms may be shifted into “panic room” mode, etc.). In some cases, the house may additionally implement other actions that may discourage the intruder and/or request assistance (e.g., playing an audible context appropriate message, flashing exterior lights, and/or notifying neighbors of the ongoing intrusion, etc.).

In another such example, a secured house may unlock a specific node to enable a delivery person to provide in-home package delivery, a service technician to perform in-home repairs, and/or permit other restricted member access. However, the secured house may keep other physical thresholds locked and/or monitor for suspicious behavior. Suspicious behavior might include attempting to unlock other doors, travel outside of an acceptable zone, excessive duration, etc. Depending on the degree and/or sensitivity, an administrator and/or enforcement authorities may be notified of anomalous/urgent conditions.

As used herein, a node may refer to any logical entity of the system. For example, a system might incorporate nodes such as e.g., physical access resolution devices (e.g., context-based doors and/or locks, etc.), user devices (e.g., smart phone, etc.), as well as other networked peripherals (e.g., surveillance cameras, alarms, remote sensors, and/or other Internet of Things (IoT) appliances, etc.).

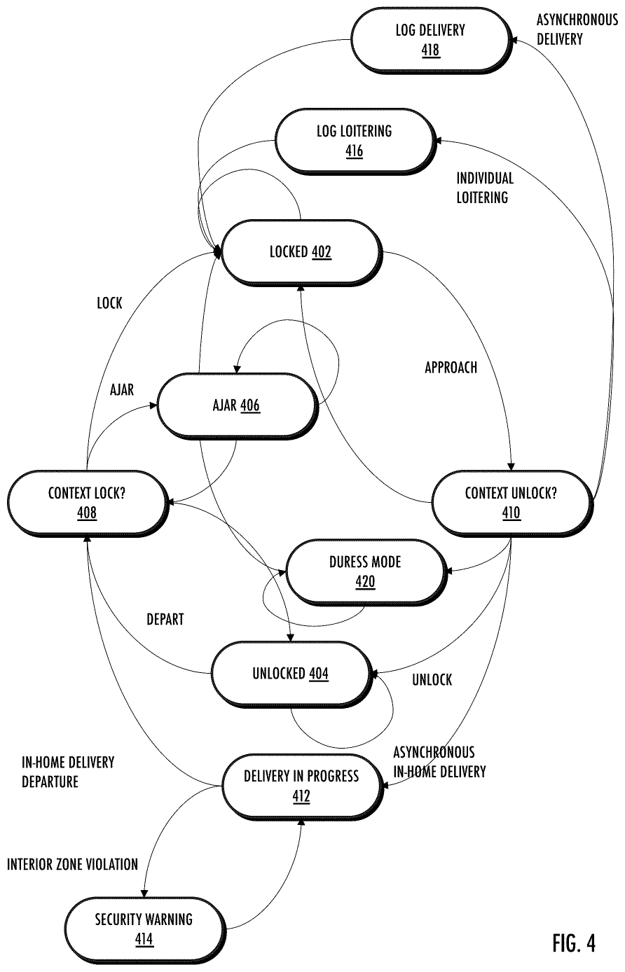

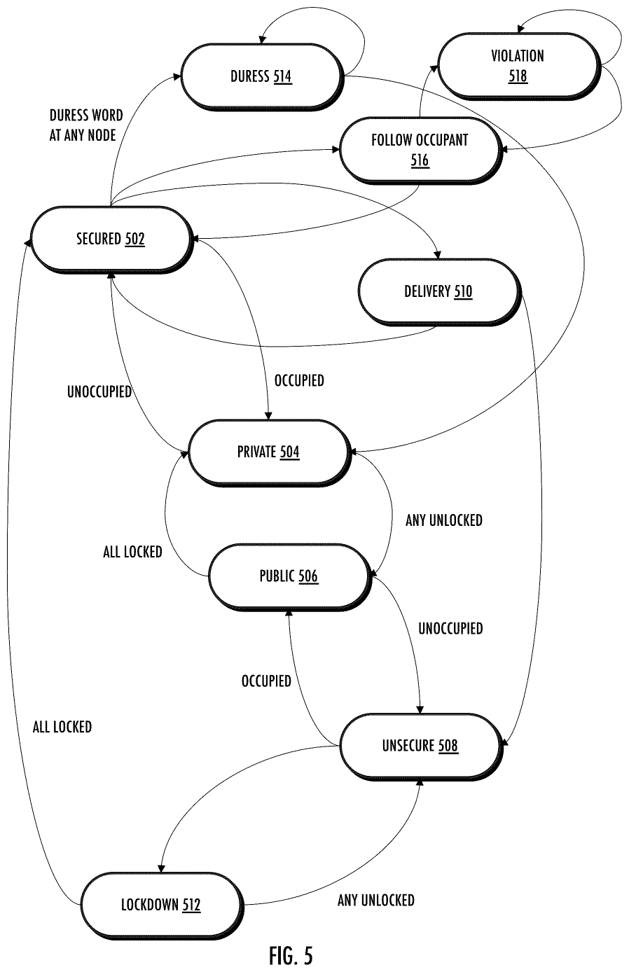

One state machine depicted within FIG. 4 is representative of selected scenarios for one “walk-up, walk-in” lock implementing the physical access resolution techniques described herein. The interconnecting relationships between states and events enumerated within Table 1 below, are depicted within FIG. 4. A more comprehensive implementation of states and definitions is provided within APPENDIX A, the following being purely illustrative.

TABLE 1
Selected Node States and Events

| Type | Sub-type | Category | Name | Description |
|---|---|---|---|---|
| State | Access | Routine | Locked | Lock event success or unlock event |
| | | | | fail |
| State | Access | Routine | Unlocked | Unlock event success or lock event |
| | | | | fail |
| State | Access | Urgent | Ajar | Threshold cannot close/lock. |
| State | Access | Routine | Context Lock | Check context for locking |
| State | Access | Routine | Context | Check context for unlocking |
| | | | Unlock | |
| State | Delivery | Anomalous | Delivery in | Known delivery person crosses the |
| | | | Progress | threshold completely or partially, |
| | | | | drops off the package within the |
| | | | | user designated Drop Off Zone |
| State | Delivery | Urgent | Security | Play recorded warning message, |
| | | | Warning | call 911, etc. |
| State | Access | Anomalous | Log Loitering | Log a loitering individual detected |
| | | | | in Exterior Security Zone. |
| State | Delivery | Anomalous | Log Delivery | Log a delivery person detected in |
| | | | | Exterior Security Zone. |
| State | Access | Urgent | Duress Mode | User has used a “duress word” to |
| | | | | unlock the house. |
| Event | Access | Routine | Lock | Context triggers lock |
| Event | Access | Routine | Unlock | Context triggers unlock |
| Event | Access | Urgent | Ajar | The node cannot close |
| Event | Access | Routine | Approach | A detected approach of a person |
| Event | Access | Anomalous | Tag-along | A member and non-member |
| | | | | approach. |
| Event | Access | Routine | Depart | A detected departure of a person |
| Event | Delivery | Anomalous | Asynchronous | A known delivery person with a |
| | | | In-Home | package is approaching for Inside |
| | | | Delivery | Delivery Event |
| Event | Delivery | Anomalous | In-Home | Known delivery person re-crossing |
| | | | Delivery | the threshold to egress back |
| | | | Departure | outside distancing away from the |
| | | | | threshold. |
| Event | Delivery | Routine | Depart | Known delivery person has |
| | | | | dropped off package and is |
| | | | | departing. |
| Event | Delivery | Urgent | Interior Zone | A Service Individual or Service |
| | | | Violation | Company Member goes past the |
| | | | | Interior Security Zone. |

During “walk-up, walk-in” operation, a context-based door may be responsible for monitoring one physical threshold having different proximity zones (such as was illustrated in FIG. 2).

Consider a scenario where the context-based door is in the Locked State 402—the context-based door remains in the Locked State 402 until a person approaches. When a person approaches (Approach event), the context-based door transitions to the Context Unlock state 410. In this state, the context-based door obtains contextual information and determines whether to unlock. As previously described above, the context-based door may check a multi-factor hybrid key to authenticate the person.

In this case, the person approaches with a bag of groceries and speaks a password; the person also has a smart phone that has a unique device identifier. The multi-factor hybrid key confidently authenticates the person as the primary home owner, based on the computer-vision facial recognition, device identifier, voice-biometrics and secret word. Even though the user is holding groceries, additional challenges are unnecessary and the context-based door may unlock (Unlock Event transitioning to Unlocked State 404) and may even actuate an opening mechanism (e.g., electro-mechanical actuators, pneumatics, etc.) to allow the user to “walk-up, walk-in.”

After depositing the groceries inside the house, the user may walk back outside (Depart Event), causing the context-based door to transition to the Context Lock state 408. In this state, the context-based door obtains contextual information and determines whether the door should be locked. In this case, the context-based door may determine that the user will likely return with additional loads of groceries; as a result, the context-based door returns to the Unlocked State 404, allowing the user to continue to bring additional groceries in the house, etc. More generally, the context-based door may remain in the Unlocked State 404 until explicit instruction and/or implicit contextual information indicates a locking event.

A little later, the user decides to take their dog out for a walk—as the user prepares to depart (Depart Event), the context-based door transitions to the Context Lock state 408. Here, the contextual information appears to indicate that the user is leaving the house for a while—the context-based door attempts to close and lock the door; unfortunately, the user has inadvertently left an obstruction (e.g., a door stop) that prevents the door closing. The door transitions to the Ajar State 406; the door notifies the user (and the broader system) that it has been left ajar, and the house is currently unsecure (discussed in greater detail below). When the user returns to remove the obstruction the context-based door re-evaluates contextual information and successfully locks (transitioning to Locked State 402).

While the user is out walking the dog, an unknown person approaches the door. The context-based door does not recognize the person's face nor any devices that are nearby (presumably carried by the person). The context-based door notifies the person that they are being recorded, and asks the person to speak the password, etc. The person might realize that they are at the wrong address and leave immediately or they might attempt the password and fail; regardless, the event is logged as a loitering event (e.g., Individual Loitering event transition to Log Loitering 416) for the home owner to review later. More generally, however, a variety of other events and/or states might be used to escalate (e.g., notify law enforcement, trusted neighbors or other 3^{rd} parties, etc.) and/or de-escalate the situation (e.g., connect a voice call to the home owner for further explanation, etc.).

A short while later, another person approaches the door. The context-based door identifies the person as a delivery person that is employed by a delivery company (organizations may be treated as “members”), based on facial recognition, courier device identity, etc. Here, the context-based door recognizes the situation as a delivery-in addition, since the unknown loitering person might be nearby, the system enables Asynchronous In-Home Delivery. The door is unlocked for the delivery person to drop the parcel off inside the house (Asynchronous In-Home Delivery Event transition to Delivery in Progress State 412). The delivery person intentionally (or accidentally) leaves the permitted interior security zone (Interior Zone Violation Event), which triggers a Security Warning State 414. The delivery person is notified that they have exceeded their granted permissions and the monitoring feed will be provided to their employer, and potentially law enforcement for review. The delivery person returns to the interior security zone and leaves the premises uneventfully (In-home Delivery Departure Event), whereupon the door returns to the Context Lock State 408, and successfully locks (Lock Event transition to Locked State 402).

Later, another person approaches the door (Approach Event transition to Context Unlock State 410). The door cannot identify the person (e.g., unrecognized face, unrecognized face, no courier device, etc.), but determines that the person is carrying a package. Here, the door remains locked (Asynchronous Delivery Event transition to Log Delivery State 418), and records the person leaving the package on the porch. The user is notified of the delivery, and they may retrieve a video of the event to determine whether to return home.

As one final example, the home owner returns late at night. However, the home owner is accompanied by another person. The tag-along is unknown (based on device identifiers, facial recognition, etc.). In this case, the home owner has set system-wide policies that require more stringent authentication for tag-along events (i.e., regardless of how confidently the home owner is identified). For example, the member is prompted to use a voice password.

If the user provides their normal password, then the node performs normal context locking and may also log the unknown person as a guest member. However, if the user uses a “duress word” then the node will flag a duress event to the system—the system transitions all nodes (including the current node) to Duress Mode State 420. In Duress Mode State 420, each node begins monitoring the situation. If the unknown person peacefully leaves, then the home owner can de-escalate back to normal operation. However, if the situation escalates further, then the system may take more active measures. For example, the home owner's trusted friends and/or law enforcement may be notified. The unknown person may be explicitly warned that the system is recording their identifying information and monitoring their actions. In some cases, the doors may be armed to automatically close and lock as soon as the member and the non-member are in different rooms. A variety of other deterrence mechanisms may be implemented with equal success.

While the foregoing examples are presented in the context of node-specific state machines, there may be situations where the system (or user) commandeers the node to perform tasks (discussed in greater detail below). For example, certain system states may need contextual information at a specific node, to assess the system state. As but one such example, an in-house repair person may move throughout the residence while they are performing their task—the system may need to “follow” the repair person monitoring them as they work. System-driven tasks may either augment or even over-ride the node's own operations—e.g., a system may over-ride context locking to allow/prevent access to a repair person.

More directly, conventional smart locks operate as binary access gateways (verifying a user's identity e.g., via passcode or biometrics) but provide no further action/security beyond the initial access protection (locking and unlocking). These systems inherently lack situational awareness that enables more nuanced responses. As a result, conventional smart locks cannot address a variety of pre-access, access, and/or post-access scenarios. This creates critical security gaps: conventional smart locks cannot distinguish between admitted users (those who have successfully unlocked the door) and trusted users (those who remain within permitted activity zones without violating security protocols). Consequently, conventional smart locks cannot dynamically respond to deviations from expected behavior, rendering them inadequate for scenarios requiring real-time behavioral oversight.

Furthermore, aspects of the present disclosure integrate a variety of data (e.g., observed locally and/or system-wide) that provides complete context for ingress, egress, and related activities throughout the residence. Here, the context-based door system uses contextual information across a range of time (pre-access, access, post-access, etc.) and/or space (exterior security zone, threshold, interior security zone, etc.). Anomalous behaviors can trigger various degrees of escalation and/or de-escalation across a variety of different states. Artisans of ordinary skill in the related arts, given the contents of the present disclosure, will readily appreciate that the concepts may be broadly extended to a myriad of different states and/or events, the foregoing being purely illustrative.

It may be inconvenient to account for the variety of different scenarios that might occur. In such cases, the context-based door may additionally contact the home owner (or other permissioned user) with real-time information (video, audio, etc.) to obtain the user's explicit instruction for response. In some cases, the user's instructions may be further codified for subsequent use. For example, the home owner might grant access to an unknown person as a temporary guest—the context-based door may obtain, request, and/or set-up the guest's information (e.g., biometric information, device information, passwords, etc.) for future usage. In some cases, the home owner may further restrict the guest's access based on e.g., time, location, activity, etc.

User driven responses may choose from a variety of different behaviors across different situations. For example, a user may configure pre-access states to provide notifications to approaching people that the context-based door is monitoring their activities. A user could fine-tune access states to handle different levels of confidence for different users (e.g., home owner, delivery person, guests, pets, etc.). Similarly, a user could change how post-access states monitor and/or react to different types of activities within interior zones (e.g., living room, kitchen, bedrooms). Each zone may be explicitly configured with a set of permitted actions (e.g., “delivery person may deposit packages in the living room zone”, “repair technician may access the living room but not bedrooms”, etc.). Permissions may be granted according to time, location, activity, etc. Contextual information may also be shared across nodes; e.g., service personnel might enter one door, but leave out another, etc.

As alluded to elsewhere, multiple context-based nodes may coordinate their activity to create a context-based system. One state machine depicted within FIG. 5 is representative of selected scenarios for physical access resolution techniques that utilize system-wide contextual information. The interconnecting relationships between states and events enumerated within Table 2 below, are depicted within FIG. 5. A more comprehensive implementation of states and definitions is provided within APPENDIX A, the following being purely illustrative.

TABLE 2
Selected System States and Events

| Type | Sub-type | Category | Name | Notes |
|---|---|---|---|---|
| State | Access | Routine | Secured | All thresholds locked and |
| | | | | residence is unoccupied |
| State | Access | Urgent | Unsecured | Any threshold unlocked and |
| | | | | the residence is also |
| | | | | unoccupied |
| State | Access | Routine | Private | All thresholds locked and |
| | | | | residence is occupied |
| State | Access | Routine | Public | Any threshold unlocked and |
| | | | | residence is occupied |
| State | Access | Anomalous | Delivery | Specific threshold unlocked |
| | | | | for specific purpose. |
| State | Access | Urgent | Lockdown | System attempts to lock all |
| | | | | thresholds. |
| State | Access | Urgent | Duress | System unlocks doors, |
| | | | | monitors occupants, and may |
| | | | | trigger silent alarm. |
| Event | Access | Routine | Unoccupied | No people are detected within |
| | | | | the residence. |
| Event | Access | Routine | Occupied | At least one person is |
| | | | | detected in the residence. |
| Event | Access | Routine | All Locked | All thresholds are locked. |
| Event | Access | Routine | Any Unlock | At least one threshold is |
| | | | | unlocked. |
| Event | Access | Anomalous | Delivery Request | A specific member requests a |
| | | | | specific threshold be |
| | | | | unlocked for a specific |
| | | | | purpose. |
| Event | Access | Anomalous | Delivery Completed | A specific member departs |
| | | | | and locks a specific threshold. |
| Event | Access | Urgent | Duress Word | System detects a duress |
| | | | | situation. |

During system operation, the system state of the residence is used to assess system-wide behaviors. As noted elsewhere, system state is distinct from node state; the state of any single door is different than the state of the building. For example, an interior zone of the building may not be “secure” unless all of the physical thresholds (doors, windows, etc.) are “locked”. Similarly, a multi-building residence may not be secure unless all of its buildings are secure.

Consider a scenario where a home owner wakes up in the morning; their physical access resolution system is in the Private State 504—the residence is currently occupied and all the access points are locked. The user opens their front door (Any Unlocked Event) transitioning the residence to a Public State 506. In the Public State 506, the system allows certain (or possibly any) people to access the residence; for example, neighbors may be allowed to visit while the home owner is present. Even though the physical access resolution system is not controlling access to the residence, it may still continue to monitor visitors to ensure that activities are not problematic or otherwise anomalous.

Later in the afternoon, the home owner locks their doors (All Locked Event) transitioning to the Private State 504 and prepares to leave to run some errands. Once the home owner has left (Unoccupied Event), the physical access resolution system transitions to the Secured State 502. In the Secured State 502, each context-based access point (doors, windows, etc.) switches to a heightened security state—for example, the neighbors that were previously allowed access may no longer be allowed access.

While the home owner is away, a delivery person arrives to perform an asynchronous in-home delivery (such as was described above with reference to FIG. 4). From a system perspective, the Delivery Requested Event transitions the residence to the Delivery State 510 which allows a specific context-based node to unlock for a specific purpose. In this case, only the front door unlocks for only the delivery person (based on verification at an appropriate confidence level) to permit access to only the interior security zone for a specified duration for parcel delivery. Notably, the Delivery State 510 does not permit the delivery person to enter from unexpected access points or otherwise exceed the bounds of permission without triggering urgent countermeasures (as discussed in greater detail elsewhere).

If delivery proceeds as expected, then the Delivery Completed Event transitions the system back to the Secured State 502. In this case, however, the delivery person leaves in a rush closing the door but an obstruction leaves the door ajar and prevents normal context locking. Since at least one door is unlocked (Any Unlocked Event), the system transitions to the Unsecured State 508. In the Unsecured State 508 the system seeks resolution without an occupant's physical presence. Here, the home owner is notified of the Unsecured State 508; the home owner may attempt a remote lockdown (Lockdown State 512); if successful then the residence returns back to the Secured State 502. However, if unsuccessful, then the home owner may attempt to contact their neighbor (or other member in their circle of trust) or return home. The Unsecured State 508 may additionally provide real-time information to the user (e.g., video, audio, etc.) to allow for monitoring and/or escalate to call emergency services as-needed, etc.

Lastly, FIG. 5 illustrates one system-wide duress mode, useful to demonstrate how emergency and/or disaster modes may be coordinated across a residence. In the illustrated example, whenever any node of the system initiates duress mode operation, the system shifts all nodes into duress operation (Duress State 514).

Nodes may handle duress according to their own capabilities. For example, some nodes may continuously monitor the occupants and report information. This may be used by the system and/or nodes to determine whether the unwanted occupant has escalated/de-escalated the situation. Sensed data may include e.g.: the location of occupants, their physical activity, audio (e.g., shouting, whispers, etc.), video (e.g., for documenting violence), etc. In some cases, nodes may have capabilities that can help the home owner to escape and/or defuse the situation. For example, doors may automatically shut and/or lock when the occupants are in different rooms. In some cases, the nodes may use alarms and/or messages to inform the occupants of its actions (e.g., continuous monitoring, contact with law enforcement/trusted friends, etc.)

While the foregoing example is presented in the context of a home owner that allows an uninvited person to enter the residence under duress, there are other emergency and/or disaster scenarios that may also benefit from system-wide coordination. As but one such example, the system may have modes that address fire, gas leaks and/or toxic (carbon monoxide, radon, etc.). Home owners may also want configure the system to handle known health disorders (e.g., sleep walking, mental health, dementia, etc.).

As previously alluded to, the system may also support system-driven operation. System-driven operation refers to tasks and/or behaviors that are assigned to nodes of the system based on e.g., system state and/or explicit user instruction. System-driven operation may allow the system to coordinate nodes based on holistic considerations (e.g., is a repair person acting suspiciously, is a pet behaving mischievously, etc.).

In one such scenario, a repair person is scheduled to arrive while the home owner is away. Initially, the repair person is unknown, but they may be affiliated with an organization that is a member of the residence. The system can provide the repair person's identity pack to the permitted nodes (e.g., front door, living room, kitchen) allowing the nodes to independently manage context unlocking normally.

Once the repair person has entered the house, the system may transition to a Follow Occupant State 516 (rather than the Private or Public States). In this mode, the system instructs various nodes to continue to monitor and report on the repair person's activities. The repair person may be permitted to freely roam through permitted zones (e.g., kitchen, living room), for permitted times (between 2 PM and 5 PM, etc.), and purposes (e.g., plumbing, etc.). If the repair person deviates from their permitted zones, then the system may transition to the Violation State 518. Violation State 518 may implement a variety of deterrence countermeasures. For example, the home owner's trusted friends and/or law enforcement may be notified. The unknown person may be explicitly warned that the system is recording their identifying information and monitoring their actions. A variety of other deterrence mechanisms may be implemented with equal success.

While the foregoing discussion presends a system-driven scenario for in-house repair, the concepts may be more broadly extended to other applications. For example, a home owner may create a system flow that follows their pets activities, and triggers corrective action when the pet is misbehaving, etc. Similar system-driven flows may be helpful for following elderly residents and children.

More generally, conventional smart locks operate as isolated access mechanisms that manage entry and exit at a single point of entry-unlocking a door upon verification of a user's identity but providing no system-wide security coordination. However, this limited purview can expose a vulnerability where there are multiple points of access. For example, a smart lock that unlocks the front door for a delivery person does not prevent unauthorized access through the back door or garage door, etc.

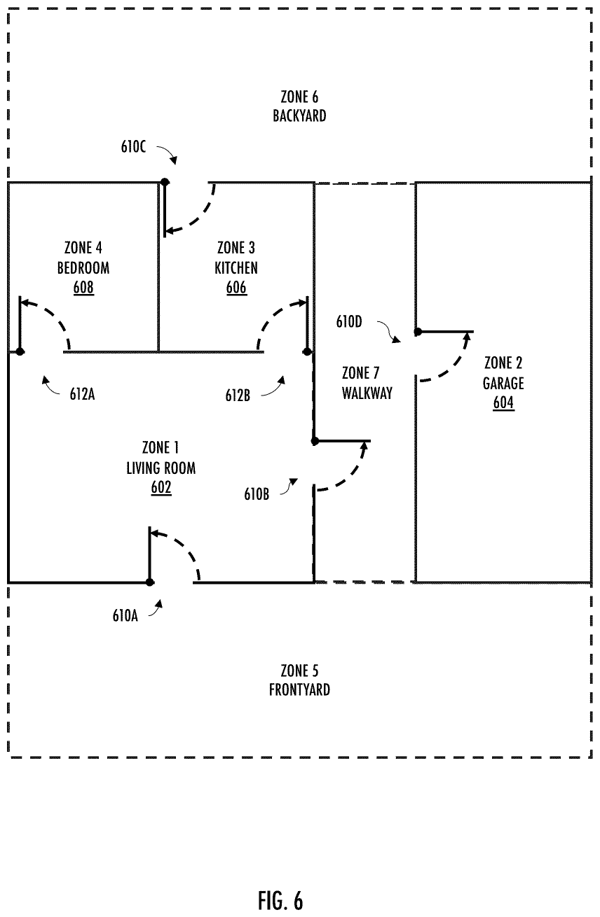

FIG. 6 is a graphical representation of one residence useful to illustrate various system-wide aspects of the present disclosure. As shown, the residence includes a first building that has: a living room 602, a kitchen 606, and a bedroom 608; the residence also has a detached garage 604.

The exterior and interior doors of the residence are further controlled by a number of physical access resolution devices; the exterior doors may be purpose-built context-based doors (610A, 610B, 610C, 610D), whereas the interior doors may have aftermarket context-based locks (612A, 612B) that are fitted into interior doors. Here, context-based doors (610A, 610B, 610C, 610D) may have multiple sensory modalities (e.g., 360° cameras, facial recognition, voice microphones, etc.) and/or capabilities (e.g., continuous monitoring, verbose logging, etc.) that are focused on identification and/or authentication. Aftermarket context-based locks (612A, 612B) may have different functionality and/or capabilities for cost/functionality trade-offs, etc. Interior activity may require less rigorous security and/or may also have privacy considerations. These devices may only monitor for occupancy using e.g., infrared, ultrasonic, microwave, radar, remote vital sign detection (heart beat detection, respiration), etc.; other features such as smoke detection, radon, and/or carbon monoxide may be bundled as safety features.

In this case, a physical access resolution system monitors the system-wide context using contextual information from each of its constituent nodes. The physical access resolution system has subdivided the residence into four interior zones (Zone 1 living room 602, Zone 2 garage 604, Zone 3 kitchen 606, and Zone 4 bedroom 608) along with 3 exterior zones (Zone 5 frontyard, Zone 6 backyard, Zone 7 walkway). The context-based doors (610A, 610B, 610C, 610D) may provide 360° monitoring of their respective thresholds—e.g., the front door 610A monitors both exterior Zone 5 frontyard and interior Zone 1 living room 602, the side door 610B monitors both exterior Zone 7 walkway and Zone 1 living room 602, the back door 610C monitors both exterior Zone 6 backyard and interior Zone 3 kitchen 606, the garage door 610D monitors both Zone 7 walkway and interior Zone 2 garage 604. The aftermarket context-based locks (612A, 612B) may monitor their respective zones—e.g., Zone 1 living room 602, Zone 3 kitchen 606, and Zone 4 bedroom 608.

As previously alluded to, the system-wide state for the residence may be based on the collective lock status of the exterior purpose-built context-based doors (610A, 610B, 610C, 610D). In other words, the residence may be considered in a secure and/or private state only when all of the context-based doors (610A, 610B, 610C, 610D) are locked. If any of these doors are unlocked, then the residence is in a public and/or unsecured state.

Notably, system-wide context could be used to further mitigate exposure during a security breach. Consider the asynchronous in-home delivery scenario described above; the front door 610A controls access between exterior Zone 5 frontyard and interior Zone 1 living room 602—during a parcel delivery, the delivery person is allowed to enter the front door 610A to drop off the parcel. However, in this case, the delivery person breaches the interior security protocol. In response the front door 610A may provide a system-wide alert that causes the interior doors (612A, 612B) to context lock and prevent further access to the Zone 3 kitchen 606, and Zone 4 bedroom 608; the garage door 610D also remains locked securing Zone 2 garage 604. Even though the residence remains in an unsecured state, the delivery person cannot access the home owner's other private areas.

As but another example, consider the door left ajar scenario where a home owner leaves the house but has forgotten that they have left their garage door 610D propped open. In response the garage door 610D may enter its ajar state and provide a system-wide alert. However, in this case, since only Zone 2 garage 604 is affected, the user may review the alert and decide to de-prioritize it until they return home.

Artisans of ordinary skill in the related arts, given the contents of the present disclosure, will readily appreciate that the scenarios described above are purely illustrative of the broader concepts described throughout.

### 2.1 Other Context-Based Flows

As previously alluded to, context-based mechanisms (locking and/or unlocking) operate on contextual information, which is different than automatic mechanisms. To illustrate this point, auto-unlock allows a person to open a door as they approach the door with a smart device; e.g., the smart device performs the requisite messaging to authenticate the user and trigger an unlock. However, anecdotal evidence suggests that users may avoid using auto-lock (the complement of auto-unlock) because it introduces situations that are inconvenient and/or dangerous—e.g., a person may be locked out of their house if they lose their device, etc.

Context-based mechanisms allow the context-based lock to assess a current situation independent of the user's smart device. In many cases, this avoids the necessity of carrying a device, while still being more convenient than conventional automatic implementations based on e.g., passcode, time, etc. Furthermore, while a door's primary purpose is to secure human access, doors also have secondary purposes—for example, doors may be opened to let a breeze in, allow pets access, or to provide a view. In fact, context-based doors that have actuating capabilities may even remain open until circumstances require the system to close and lock them. In other words, the door may be locked or unlocked (and in some cases, open) when no one is attempting access. Ideally, context-based mechanisms can be relied on to provide both robust and convenient security—e.g., a home owner may be put at ease knowing that their house will lock even if they forget to do so, while also enabling re-entry even if they forgot their PIN, smart device, etc.

Various aspects of the present disclosure are presented within the context of a context locking (“context-locking”) scenario. In one specific implementation, context-locking may be further bifurcated into “arrival-locking” which is triggered by contextual factors that are associated with the arrival of a person, and “departure-locking” which is triggered by contextual factors that are associated with the departure of a person. Artisans of ordinary skill in the related arts will readily appreciate that the concepts may be readily adapted to context-unlocking applications (arrival-unlocking, departure-unlocking, etc.) with equal success.

In one specific embodiment, context-locking is based on system state. System state may monitor a user at one or more nodes, after an access event (post-access) to determine whether/when to context-lock. In one specific embodiment, context-locking may be based on context from the access node itself (e.g., Entry Event). Consider an Entry Event scenario where a person approaches the exterior zone of a door as detected by the external 180° camera (Entry Ramp Up state). The person unlocks the door (e.g., manual unlock, context-unlock, etc.) then the person crosses the physical threshold completely, closes the door, and continues ingress into the interior zone. Once the person has traveled a pre-defined distance from the physical threshold as detected by the internal 180° camera (Entry Ramp Down state), the lock will contextually engage (arrival-locking based on member approach).

In the foregoing example, arrival-locking occurs after a user crosses the physical threshold (locking after the user has entered). However, arrival locking may also occur before a user attempts to cross the physical threshold (to prevent a person from entering). Consider an Entry Event scenario where a person approaches the exterior zone of a door as detected by the external 180° camera (Entry Ramp Up state). The system does not recognize the person and/or their multi-factor hybrid key is invalid; in response, the system pre-emptively closes the door (if not already closed), and contextually engages the lock (arrival-locking based on non-member approach).

More generally, an Entry Event may be triggered whenever a person approaches the physical threshold from an exterior zone, crosses the physical threshold, and departs the physical threshold into the interior zone. Additional contextual information may trigger transitions to other node states. For example, an Entry Ramp Up state may transition to a Multiple Entry Ramp Up state when additional persons are detected approaching the physical threshold; an Entry Ramp Up state may transition to a Tailgater Ramp Up state when another person approaches the physical threshold before the physical threshold is closed.

Each state may monitor conditional events to trigger transitions; transitions may be configured by default or explicitly by the user. For example, a time-based context-lock may set a time duration before attempting to context-lock. A presence-based context-lock may identify persons that are present at an unlock event, the door will count each person that enters (or departs without entry), and context-lock when the count is satisfied. A maximum tailgater context-lock may count the number of persons crossing the physical threshold, the door may attempt to close and context-lock once a set number is met/exceeded. A no-tailgater context-lock may actively attempt to prevent tailgaters (close and lock after each person). Violations to routine behavior may trigger an Intrusion state that launches anomalous and/or urgent countermeasures (e.g., notifying administrator and/or emergency services). Any number of other conditions may be substituted with equal success.

In some cases, the context-locking behavior may be based on other conditional and/or environmental factors. For example, time of day adjustments may increase, decrease, and/or select between tailgate restrictions, etc. As another example, so-called “party” or “pet” states may disable excessive locking and unlocking (churn) caused by e.g., a party, a pet that has a pattern of frequent ingress/egress during certain times, etc. Context-locking may also consider occupancy limits based on the system's knowledge of current occupants. Various other system state considerations may be substituted with equal success.

An Exit Event may be triggered whenever a person approaches the physical threshold from an interior zone (Exit Ramp Up state), crosses the physical threshold, and departs the physical threshold into the exterior zone. Once the person has traveled a pre-defined distance from the physical threshold as detected by the external 180° camera (Exit Ramp Down state), the lock will contextually engage (departure locking). Much like entry states, exit states may transition to other states. For example, an Exit Ramp Up state may transition to a Multiple Exit Ramp Up state when more than one person approaches the physical threshold; an Exit Ramp Up state may transition to a Tailgater Exit state when another person approaches the physical threshold before the physical threshold is closed, etc.

A Simultaneous Entry and Exit Event (SEEE) may occur where multiple persons enter and exit through the same physical threshold without allowing the physical threshold to close. SEEEs may be particularly common in multi-dwelling/commercial settings. As one illustrative example, a first person approaches from the exterior zone (detected via the external 180° camera)—initially, this may be similar to an Entry Ramp Up state. A moment later, a second person approaches from the interior zone (detected via the internal 180° camera); responsively, the system switches to the SEEE Ramp Up state. When both the first person and the second person have crossed the physical threshold, closed the door, and both persons have progressed beyond a pre-defined distance, then the door will context-lock (SEEE Ramp Down state).

Package delivery scenarios are another common application for context-locking functionality. As but one such example, a “Synchronous Delivery” occurs where a delivery person and an occupant interact across the physical threshold. A Synchronous Delivery Event may be triggered by the approach of a delivery person (a non-member or a member having package delivery permissions) and the occupant answering the door a moment later (Synchronous Delivery Ramp Up state). The occupant may take delivery inside/outside (crossing the threshold, partially crossing the threshold, remaining inside the threshold), and the delivery person departs (Synchronous Delivery Ramp Down state). Once the door is closed and the occupant has moved a pre-defined distance away from the door, the door may context-lock.

In another such use case, an Asynchronous Pick Up may be triggered by the approach of an occupant when packages are detected outside (Asynchronous Pick-Up Ramp Up state). The occupant crosses the threshold to go outside, picks certain ones of the packages, and returns inside. The door can stay unlocked while there are still packages being moved. Once the occupant has moved beyond a pre-defined distance into the interior, the door may context-lock (Asynchronous Pick-Up Ramp Down state).

Some delivery persons may have limited access to perform inside deliveries. An Inside Delivery is triggered by the approach of a delivery person (member with interior delivery permissions) from the outside with a package (Inside Delivery Ramp Up state). The delivery person crosses the threshold completely or partially and drops the package within a designated Drop Off Zone (Inside Delivery state). If the delivery person leaves then the door may context-lock (Inside Delivery Ramp Down state). Alternatively, if the delivery person proceeds in an unauthorized manner, then the system transitions to the Intrusion state.

A Guest/Visitor is triggered by the approach of a non-member (or member with guest permissions) and where an occupant approaches to answer the door (Guest/Visitor Ramp Up state). Once the guest/visitor crosses the threshold and proceeds with the occupant beyond a pre-defined threshold, then the door may context-lock (Guest/Visitor Ramp Down state).

A Person Pick Up (PPE) is triggered by the approach of a person which causes an occupant to answer the door (PPE Ramp Up). When the occupant crosses the threshold, and both people depart beyond a pre-defined distance, then the door may context-lock (PPE Ramp Down state).

As previously noted, members have registered identities with access authorization that enables context-locking/context-unlocking. Certain limited members and/or non-members may be granted limited access passes. For example, Persons with Time-Bound Access Pass may have a temporal grant, Persons with Zone-Bound Access Pass may have zonal grant, etc. The limited access passes may provide member-like access according to certain limitations—e.g., ad hoc visitors to a home (e.g., service person, etc.) may be granted access via an access pass (handled with the member states e.g., Entry Event and Exit Event, etc.). This enables context-locking and/or context-unlocking for the duration of the pass without Identity registration.

Limited access passes may need additional lock-out protection (LOP) modes. For example, Time-Bound Pass Users may experience accidental lockouts (since they are not registered with either device or biometric information) and/or may need to repeatedly use their access pass if they require repeated re-entry. When enabled, LOP mode temporarily stores user identification locally for a LOP duration. If the person exits and accidentally triggers an context-lock, the person may return and use the local user identification to trigger an context-unlock within the LOP duration. The temporary user identity will be discarded when the limited access pass expires.

### 3 System Architecture

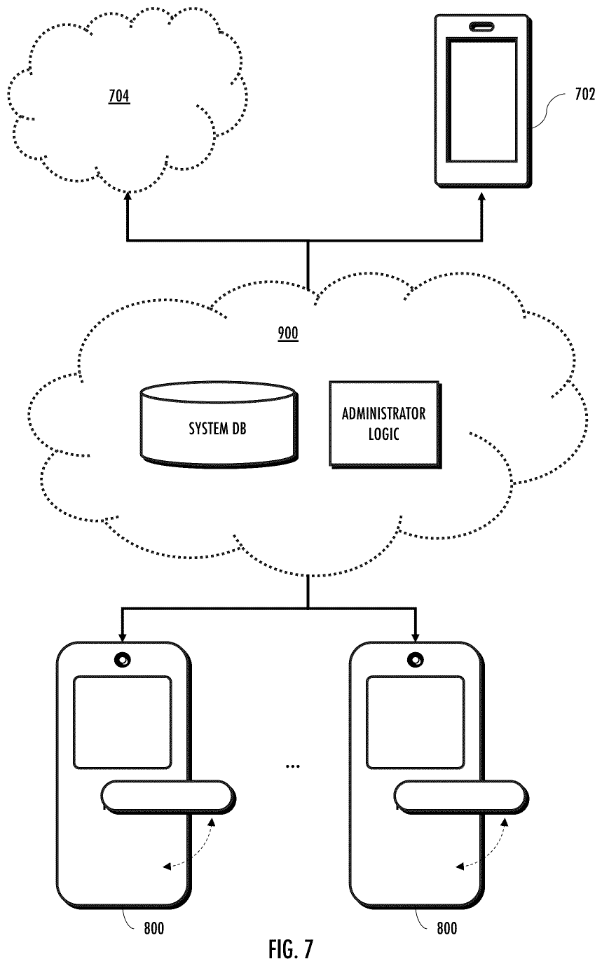

Various aspects of the present disclosure are now discussed with reference to a logical block diagram of one system for access resolution based on situational awareness depicted within FIG. 7, useful in accordance with various aspects of the present disclosure. The system of FIG. 7 includes: physical access resolution devices 800 and system administration logic 900. In some variants, the system administration logic 900 may additionally interact with user devices 702 and/or external applications via the public (or private) internet 704.

The following examples are discussed in the context of physical access resolution devices 800 that manage physical access control of a physical threshold, and system administration logic 900 that coordinates operation of the physical access resolution devices 800 to evaluate situations and/or propagate situational information (situational awareness). More generally, however, artisans of ordinary skill in the related arts will readily appreciate that the functionalities described herein may be combined, divided, hybridized, and/or augmented within different entities. For example, a physical access resolution device may directly evaluate situational awareness locally and/or broadcast information to other devices (including other physical access resolution devices). Similarly, a system administration logic 900 may be managed with a user device and/or other cloud infrastructure.

### 3.1 Physical Access Resolution Based on Situational Awareness

Physical access resolution devices refer to devices that manage physical access control of a physical threshold. Physical access control is subdivided into situation assessment (situational awareness) and access resolution (e.g., pre-access, access, and post-access action). Notably, physical access resolution may include additional activity beyond permitting and/or denying access—e.g., monitoring may continue to ensure that entrants comply with permitted behaviors, etc.

As a practical matter, physical access resolution devices may have a broad range of capability. For example, some physical access resolution devices may capture localized information (one or more of acoustic, visual, and/or electromagnetic information from the environment in addition to user inputs) to assess an access event (situational awareness). More sophisticated implementations may additionally incorporate information from other entities of the system (e.g., other physical access resolution devices, system administrator, and/or user devices). Complex implementations may also interact with 3^{rd} parties beyond the system to e.g., obtain assistance, emergency services, etc. More broadly, any device that resolves physical access based on situational assessment may provide “physical access resolution” functionality.

Physical access resolution devices may implement localized control over its own functionality. For example, a physical access resolution device may need to operate in isolation (e.g., in the event a malicious actor attempts to disable connectivity, jam communications, etc.). In some variants, the physical access resolution device may additionally localize and/or obfuscate sensitive information (e.g., a user's comings and goings, etc.). In some variants, certain user permissions may enable the ability to provide default access settings and/or manually override localized control.

While the following discussions are primarily discussed in the context of event-driven access (e.g., a person approaching a door), physical access resolution devices may also receive and/or service access events from other entities (e.g., remote access requests). For example, a user may remotely open a door for their pet, child, etc. In some cases, the physical access resolution device may assess the remote user's environment (in addition to its local environment) for such accesses; other forms of access control may also be used (e.g., rule-based, etc.).

“Physical access control” refers to security techniques for managing entry to physical spaces such as buildings, rooms, and facilities. This can include security measures like keycards, biometric scanners, turnstiles, as well as security guards, surveillance cameras, etc. In many cases, these mechanisms are designed to authorize and authenticate individuals, devices, or entities before granting them entry or permission to the physical space.

An “access event” is characterized by a person (or other entity e.g., drone, animal, etc.) attempting access to a physical space (zone). Access events may occur at physical thresholds (e.g., door, window, gate, bridge, turnstile, checkpoint, etc.) but could also be across any spatial threshold (e.g., a “great room” may not have physical doors, but might still be separated into a kitchen, dining room, living room, etc.).

A “physical threshold” refers to a transitional partition to control ingress/egress between two or more spaces. Examples of physical thresholds may include e.g., door, window, gate, bridge, turnstile, checkpoint, etc. Depending on how a physical threshold is constructed, it may be characterized by a position, displacement, velocity, and/or acceleration along a pathway (threshold pathway). The position, displacement, velocity, and/or acceleration may be sensed along with other parameters to e.g., infer a current state of the physical threshold (e.g., a door may be open, closed, locked, unlocked, etc.).

A “zone” or “space” may be further categorized according to its use. For example, interior zones may refer to areas enclosed by the building features (walls, windows, ledges, etc.), exterior zones may refer to areas that are not enclosed by the building features. So-called “security zones” may refer to zones which are monitored for security reasons, similarly “occupancy zones” may refer to zones which are not monitored or where monitoring is used for occupational needs. In fact, zones may have different categorizations and/or overlapping regions. For example, an exterior security zone may have partial, or even complete, overlap with exterior occupancy zones, etc. A variety of other categorizations may be substituted with equal success. “Occupancy” refers to a monitored number of entities (persons, pets, vehicles, etc.) which are within a zone or space.

As a brief aside, a finite state machine (or “state machine”) refers to a machine that can only be in one of a finite number of “states”. Each state has a limited set of valid inputs, outputs, and/or data manipulations. The state machine “transitions” between states in response to certain inputs. A machine is “stateful” if it can consider preceding events or interactions in its logic (i.e., it remembers at least a current and previous state), stateless logic does not consider preceding events/interactions.

“Events” may broadly encompass any change or occurrence that has significance for operation of a system. For example, access events refer to events that trigger an access resolution. A variety of event categories are discussed throughout e.g., device events (e.g., battery events, network events, etc.), administrative events (e.g., adding a user, sending a multi-factor hybrid key, etc.), access events, delivery events, occupancy events (e.g., changes that affect the occupancy state of a residence”), etc. Still other events may be substituted with equal success, the foregoing being purely illustrative.

Events may be further categorized according to other factors. Schemes may be based on frequency, priority, risk, user-defined categories, etc. For example, a scheme for categorizing access events according to security risk and response might use e.g., routine (log only), anomalous (log, monitor, and notify), and/or urgent (log, monitor, notify, and/or initiate action).

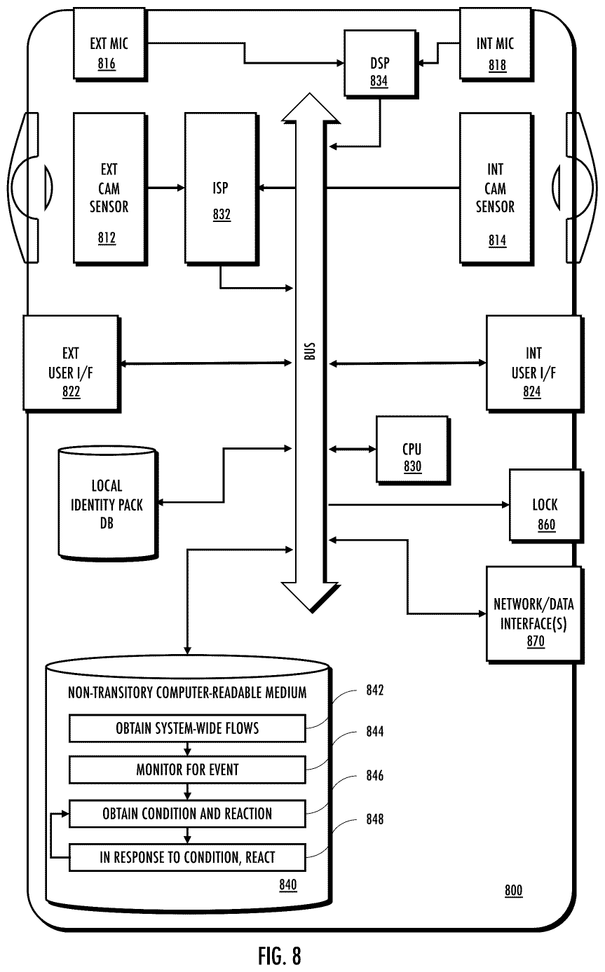

FIG. 8 is a logical block diagram of physical access resolution device 800. The physical access resolution device 800 includes: a sensor subsystem, a user interface subsystem, a data/network interface, a physical actuation subsystem, and a control and data processing logic.

The sensor subsystem captures data from the environment. The user interface subsystem monitors the user for user interactions and renders data for user consumption. The control and data processing logic obtains data generated by the user, other devices, and/or captured from the environment, to perform calculations and/or data manipulations. The resulting data may be stored, rendered to the user, transmitted to another party, or otherwise used by the device to carry out its tasks. The physical actuation subsystem actuates one or more physical mechanisms to enable/disable (lock/unlock) and/or articulate (open/close) a physical threshold to permit access. The data/network interface converts data for transmission to another device via transmission medium. In some cases, the physical access resolution device may incorporate localized power (e.g., battery power) in addition to main power (e.g., power from an outlet or other wired connection).

The various logical subsystems described herein may be combined, divided, hybridized, and/or augmented within various physical components of a device. As but one such example, an interior-facing camera and exterior-facing camera may be implemented as separate, or combined, physical assemblies. As another example, data processing logic may occur in multiple components of the physical access resolution device. More generally, the logical block diagram illustrates the various functional components of the physical access resolution device, which may be physically implemented in a variety of different manners.

Referring first to the sensor subsystem, a “sensor” refers to any electrical and/or mechanical structure that measures, and records, parameters of the physical environment as analog or digital data. The physical access resolution device may incorporate multiple different modalities of sensor data; for example, visual data may be captured as images and/or video, audible data may be captured as audio waveforms (or their frequency representations), electromagnetic radiation may be captured via antennas, biometric data may be captured via touch sensors, etc. The following sections provide detailed descriptions of the individual components of the sensor subsystem.

A camera lens bends (distorts) light to focus on the camera sensor. The camera lens may focus, refract, and/or magnify light. It is made of transparent material such as glass or plastic and has at least one curved surface. When light passes through a camera lens, it is bent or refracted in a specific way, which can alter the direction, size, and/or clarity of the image that is formed. In the illustrated embodiment, the camera lenses are “wide” FOV camera (so-called fisheye lenses provide between 120° and 195°). Other implementations may use normal FOV (between 90° and 120°), or even narrow FOV (below 90°), cameras.

A camera sensor senses light (luminance) via photoelectric sensors (e.g., photosites). A color filter array (CFA) filters light of a particular color; the CFA provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Notably, most imaging formats are defined for the human visual spectrum; however, machine vision may use other variants of light. For example, a computer vision camera might operate on direct raw data from the image sensor with a RCCC (Red Clear Clear Clear) color filter array that provides a higher light intensity than the RGB color filter array used in media application cameras.

The camera module(s) may include on-board image signal processing and/or neural network processing. On-board processing may be implemented within the same silicon or on a stacked silicon die (within the same package/module). Processing functionality is discussed further below.

During operation, the physical access resolution device may make use of multiple cameras to assess user interactions and the physical environment. For example, a first camera 812 may capture visual information from an exterior space associated with a physical threshold and a second camera 814 may capture visual information from an interior space associated with the physical threshold.

While the foregoing techniques are described in the context of perceptible light, the techniques may be applied to other electromagnetic (EM) radiation capture and focus apparatus including without limitation: infrared, ultraviolet, and/or X-ray, etc. As but one such example, an IR (infrared) sensor works by detecting infrared radiation (heat). IR sensors are commonly used to detect presence, motion, or temperature. There are two main types of IR sensors: active and passive.

An active IR sensor has two main components: an IR emitter (usually an LED) and an IR receiver (usually a photodiode or phototransistor). The IR emitter sends out a beam of infrared light, and the IR receiver detects any reflected IR and/or change in reflected IR. Based on this change, the system determines presence, proximity, or distance.

A passive IR (PIR) sensor doesn't emit anything. It only detects infrared radiation changes in its environment, usually from warm bodies like humans or animals. Typically, a PIR sensor has two slots made of pyroelectric material, which generate an electrical signal when it detects changes in IR levels. When a warm body moves across the sensor's field of view, it creates a difference between the two slots, and triggers a detection.

Audio sensors (e.g., first microphone 816, second microphone 818) are typically incorporated within an audio module that also includes speakers, and an audio codec/digital signal processor 834. The microphones sense acoustic vibrations and convert the vibrations to an electrical signal (via a transducer, condenser, etc.). The electrical signal is provided to the digital signal processor 834, which samples the electrical signal and converts the time domain waveform to its frequency domain representation. Typically, additional filtering and noise reduction may be performed to compensate for microphone characteristics. The resulting audio waveform may be compressed for delivery via any number of audio data formats. To generate audible sound, the digital signal processor 834 obtains audio data and decodes the data into an electrical signal. The electrical signal can be amplified and used to drive the speaker to generate acoustic waves.

During operation, the physical access resolution device may make use of multiple audio sensors to assess user interactions and the physical environment. For example, a first microphone 816 may capture acoustic information from an exterior space associated with a physical threshold and a second microphone 818 may capture acoustic information from an interior space associated with the physical threshold.

The audio module may include on-board audio processing and/or neural network processing to assist with acoustic analysis and synthesis. Processing functionality is discussed further below.

Cameras and microphones may additionally be used to derive other types of information. For example, a time-of-flight (TOF) sensor is a type of distance measurement sensor that uses light or sound to estimate distance. A light-based TOF sensor may use IR lasers or LED pulses to emit light waves toward a subject, and the reflected waves can be measured for time-of-flight data. The time-of-flight can be used to calculate distance. An acoustic TOF sensor uses the same principles with acoustic waves (e.g., ultrasound, etc.).

Biometric sensors are devices that detect and measure unique physical or behavioral traits to identify and/or verify individuals. Most biometric sensors follow a similar process: a sensor acquires raw biometric data, feature extraction processes it into a feature set (a “template”), and pattern matching compares the features to stored templates. Common examples include fingerprint scanners, facial recognition systems, iris and retina scanners, and voice recognition sensors. A brief discussion of illustrative biometric scanners (fingerprint and retinal) are provided, other biometric scanners may be substituted with equal success.

Fingerprint scanners use optical, capacitive, ultrasonic, or other sensing apparatus to identify a ridge and valley pattern of a fingerprint. Optical variants shine light on the finger and uses a camera to take a high-contrast image of the fingerprint. Capacitive variants use arrays of capacitor electrodes to detect the fingerprint pattern based on differences in capacitance (capacitance above a threshold is a ridge, below the threshold is a valley.) Ultrasonic variants emit ultrasonic waves to image the fingerprint; the ridges and valleys reflect the ultrasonic waves differently-ridges contact the sensor surface and reflect sound back strongly, while valleys (air gaps) reflect weakly or not at all.

A retinal scanner works by capturing the unique pattern of blood vessels in the retina, the thin layer of tissue at the back of the eye. Typically, a low-intensity infrared beam (typically 700-900 nm wavelength) is projected into the eye. Infrared is used because it's safe for the eye and penetrates the retina more effectively. The blood vessels in the retina absorb more infrared light than surrounding tissue, creating a distinct contrast pattern. An IR camera detects the reflected pattern. The scanner may sweep the infrared beam in a spiral or raster pattern to build a high-resolution map of the blood vessel structure. This scan captures features such as branching patterns, width, and positioning of the vessels.

Other components of the physical access resolution device may further augment sensor functionality. For example, the data/network interface 870 may provide electromagnetic sniffing (in addition to its communication functionality). Similarly, the user interface subsystems (first user interface 822, second user interface 824) may be incorporated with biometric scanners, etc.

Referring now to the user interface subsystem, the “user interface” refers to the physical and logical components of the physical access resolution device that interact with a human user. The user interface subsystem may encompass visual, audio, and tactile elements.

Mechanical buttons work by physically closing an electrical circuit when pressed. Typically, a spring-loaded mechanism keeps contacts apart. When pressed, the mechanism compresses and brings the contacts together, allowing current to flow through the circuit. Releasing the button causes the spring to push the contacts apart again, breaking the circuit. There are several types of mechanical buttons. Toggle switches flip between two states, like on/off, using a lever mechanism. Push-button switches are momentary or latching—momentary ones only work while pressed, while latching ones stay in place until pressed again. Rotary switches are turned to select different settings or circuits. Mechanical buttons are cost effective and can be ruggedized, but many modernized devices have moved toward resistive and/or capacitive touchscreen interfaces that “mimic” the functionality of mechanical buttons.

In addition to physical user interface devices that use buttons to register explicit user input, the user interface subsystem may also incorporate various components of the sensor subsystem to sense user interactions. For example, the user interface may include: a display module to present information, biometric sensors to capture biometric indicia, a camera to capture user gestures, a speaker to provide audible information, and a microphone to capture voice commands, etc.

The display module is an output device for presentation of information in a visual form. Common display technologies include LCD (liquid crystal display), LED (light-emitting diode), and OLED (organic LED) screens, each using different technologies to produce images. They can show static text, dynamic graphics, or video, depending on their design and purpose. The choice of display type depends on factors like brightness, resolution, power consumption, and viewing angle.

In many cases, a touchscreen interface may be overlaid to allow users to interact directly with a display by touching it. The most common types are resistive, capacitive, and infrared. Resistive touchscreens use two flexible layers that register touch when pressed together, making them durable and responsive to any touch input, including gloves or styluses. Capacitive touchscreens use the electrical properties of the human body to detect touch and support multi-touch gestures but usually require bare skin or special conductive materials. Infrared touchscreens use a grid of light beams across the screen surface, detecting touch when beams are interrupted.

As previously noted, the user interface subsystem may additionally incorporate cameras and microphones to collect the user's gestures, facial details, vocal instructions as well as the environmental images and sounds. See discussions of sensor subsystem operation elsewhere.

Functionally, the data/network interface subsystem enables communication between devices. For example, the physical access resolution device may communicate with the system administration logic, another physical access resolution device, a user device, etc. In some cases, the physical access resolution device may also need to access remote data and/or 3^{rd} parties (e.g., emergency services, etc.).

The network interface may include both wired interfaces (e.g., Ethernet and USB) and/or wireless interfaces (e.g., cellular, local area network (LAN), personal area network (PAN)) to a communication network. As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). For example, the physical access resolution device may directly connect, or indirectly tether to another device with access to, the Internet. “Tethering” also known as a “mobile hotspot” allows devices to share an internet connection with other devices. For example, a smart phone may use a second network interface to connect to the broader Internet (e.g., 5G/6G cellular); the smart phone may provide a mobile hotspot for the physical access resolution device over a personal area network (PAN) interface (e.g., Bluetooth/Wi-Fi), etc.

Functionally, the physical actuation subsystem 860 actuates, in whole or part, a physical threshold to grant/deny access. A typical mechanical lock subsystem may include a lock body, a latch or bolt, a strike plate, and an actuator. The lock body secures and protects the components of the lock subsystem to prevent malicious tampering and/or environmental fouling. The latch or bolt may be attached to a door (or other physical body) and can be extended into/withdrawn out-of the strike plate of a door frame. When the latch is extended into the strike plate (e.g., “locked”), the door is fixed within the door frame; the latch may be withdrawn to permit the door to be opened (e.g., “unlocked”). Simple electromechanical actuation may be used to actuate the latch, as instructed, by a controller application or other logic.

More generally, physical actuation may be implemented in any number of ways. Mechanical and/or electro-mechanical actuation (via solenoids, servos, and/or electric motors) etc. refers to actuation of mechanical elements (rigid bodies). Pneumatic actuation refers to actuation via compressed gasses and/or compression-based actuation. Hydraulic actuation refers to actuation via fluid transfer. Fluids are substantially less compressible than gas but are not rigid solids, thus, hydraulic actuation may provide offer design trade-offs. Magnetic and/or electromagnetic actuation are other actuation mechanisms commonly available in the related arts.

While hinged doors are the most common form of physical threshold, there are a large variety of other door styles and/or mechanisms. Examples may include, without limitation, sliding doors (e.g., bypass doors, pocket doors, rolling doors, etc.), folding doors (e.g., accordion doors, bi-fold, tri-fold, etc.), pivot doors, revolving doors, up-and-over doors, rolling/rolling shutter doors, vertical lift doors, Dutch doors, etc.

While the foregoing examples are presented in the context of opening and closing a latch/bolt and striker assembly, physical actuation may be extended to the other portions of the door and/or the whole door. For example, powered doors may be opened and/or closed to grant/deny access. For example, a sliding door may be physically actuated into a fully open, fully closed, or partially open/closed configuration by changing the amount of linear motion. Similarly, a pivot door may be physically actuated into a fully open, fully closed, or partially open/closed configuration by changing the amount of pivot motion. Powered Dutch doors may allow a first portion of the door to be opened (e.g., a window), while the lower portion remains closed.

Different door mechanisms may have different means and/or mechanisms for controlling an aperture size in various gradations; e.g., a powered hinge door may be partially opened to permit a breeze. The gradation may span e.g., fully open, fully closed, partially open/closed (e.g., 25%/75% 50%/50%, 75%/25%, etc.). Powered sliding doors and/or other door mechanisms may have similar mechanisms.

Notably, other apertures (e.g., windows, vents, etc.) may also provide physical access—examples may include e.g., single-hung, double-hung, sliding, casement, awning, hopper, jalousie/louvered, tilt, and/or other window mechanisms. More generally, artisans of ordinary skill in the related arts will readily appreciate that the techniques described within may be broadly extended to actuation, in whole or part, of any aperture mechanism or assembly with equal success.

The control and data subsystem controls the operation of a device and stores and processes data. Logically, the control and data subsystem may be subdivided into a “control path” and a “data path.” The data path is responsible for performing arithmetic and logic operations on data. The data path generally includes registers, arithmetic and logic unit (ALU), and other components that are needed to manipulate data. The data path also includes the memory and input/output (I/O) devices that are used to store and retrieve data. In contrast, the control path controls the flow of instructions and data through the subsystem. The control path usually includes a control unit, that manages a processing state machine (e.g., a program counter which keeps track of the current instruction being executed, instruction register which holds the current instruction being executed, etc.). During operation, the control path generates the signals that manipulate data path operation. The data path performs the necessary operations on the data, and the control path moves on to the next instruction, etc.

The control and data processing logic may include one or more of: a central processing unit (CPU 830), an image signal processor (ISP 832), and digital signal processor (DSP). In some variants, the device may also include one or more neural network processors (NPUs), and their corresponding non-transitory computer-readable media 840 that store program instructions and/or data. In one exemplary embodiment, the control and data subsystem includes processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

Different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: operating system (OS) functionality (power management, UX), memory management, gesture-specific tasks, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks and must account for branch disruption and/or arbitrary memory access.

In contrast, the image signal processor (ISP) and digital signal processor (DSP) perform many of the same tasks repeatedly over a well-defined data structure. For example, the ISP maps captured camera sensor data to a color space. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. DSP operations are also similar in definition, operation, similarity, and specialization. Acoustic waveforms are of known sample size, may include specialized FFT (or derivative) logic, and highly repetitive.

In some cases, the device may include one or more neural network processors (NPUs). Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Other processor subsystem implementations may multiply, combine, further subdivide, augment, and/or subsume the foregoing functionalities within these or other processing elements. For example, multiple ISPs may be used to service multiple camera sensors. Similarly, neural network functionality may be subsumed with either CPU or ISP operation via software emulation.

In one embodiment, the control and data processing subsystem may be used to store data locally at the device. In one exemplary embodiment, data may be stored as non-transitory symbols (e.g., bits read from non-transitory computer-readable mediums). In one specific implementation, a memory subsystem including non-transitory computer-readable medium is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use.

In some embodiments, the program code may be statically stored within the device as firmware. In other embodiments, the program code may be dynamically stored (and changeable) via software updates. In some such variants, software may be subsequently updated by external parties and/or the user, based on various access permissions and procedures.

One specific implementation of the physical access resolution device 800 may include a non-transitory computer-readable medium that includes a routine that handles access events according to a “flow” of processing (e.g., a state machine). When executed by the control and data subsystem, the routine causes the physical access resolution device to: obtain system-wide flows, detect events, obtain a set of conditions and reactions associated, and when conditions are met execute the corresponding reaction. The following discussion explores these steps in more detail.

At step 842, the physical access resolution device obtains system-wide flows, system updates, identity packs, and/or situational information (if any). A “flow” refers to a set of conditions and associated reactions; typically implemented as state machine logic. Within the context of the present disclosure, the physical access resolution device may have its own default flows (e.g., context lock, context unlock, etc.), but can also coordinate with a broader physical access resolution system administration layer to implement more complex behaviors.

In one embodiment, the physical access resolution device registers with physical access resolution system administration logic during an initial set-up process. In some variants, the physical access resolution device may obtain the network address of a physical access resolution server during an installation/configuration process. In other cases, the physical access resolution device may periodically search for, and discover, the network address of a physical access resolution server using e.g., wireless beacons and/or other discovery mechanisms.

During the initial configuration, the physical access resolution device may identify its capabilities and/or functions to the system administration logic. Capabilities may include sensor capabilities (e.g., number of sensors, types of sensors, sensor range, sensor modalities, etc.), processing capabilities, operational life (e.g., battery life, on-board memory), lock/unlock, etc. For example, purpose-built context-based doors may have multiple sensory modalities (e.g., 360° cameras, voice microphones, etc.), on-board processing capabilities (e.g., facial recognition, voice recognition, etc.), memory and power for local processing (e.g., identity pack storage, video/audio capture, battery-powered lock actuation, etc.), keypads for manual key entry, and a number of locking modes, actuations, and/or physical actuations (e.g., primary lock/unlock, pet door lock/unlock, assisted open/close, physical key support, etc.). Aftermarket context-based locks may be sold as “bolt-on” upgrades for doors/windows, etc. Such devices may have different capabilities e.g., IR cameras, actuators that replace existing door locks, etc.

In addition, the system administration logic may additionally provide contextual information to the physical access resolution device in view of its installed location. In other words, a door might be installed at the front door, within the interior, at a peripheral door (garage door, side door, etc.)—the system administration logic may, based on its installed location-permit and/or deny certain operational flows. For example, the system administration logic may restrict asynchronous in-home delivery flows to just a single door of the household. Similarly, certain system-wide situations (e.g., duress modes, evacuation, etc.) may require a specific door to either remain locked, unlocked, monitor, and/or react specified ways.

As a practical matter, security and/or surveillance appliances exist within a broader ecosystem of home appliances and 3^{rd} party vendors and services that may change on a regular basis. System-wide coordination may include scheduled maintenance to ensure that the system remains operational and current. For example, system administration logic may specify scheduling for firmware updates and/or data transfers. This may also enable nodes to update and/or receive identity pack updates (member additions/removals, etc.), archive security footage, etc. System administration logic may additionally use this to ensure that new system-wide capabilities and/or functionality is discovered and/or timely implemented.

Various embodiments may enable both default behaviors as well as user-configured behaviors. Most home owners are likely to set up the system relying on a set of default rules after initial installation. However, as discussed elsewhere, system administration logic may be modified with new flows that are tailored to the user's usage patterns, and identity packs that are learned from monitored traffic. Typically, these changes may be managed via a user's administration device (e.g., smart phone, laptop, etc.) which is then propagated to the nodes via system updates. Other variants may allow changes to be made at a node and propagated to other nodes—e.g., a new guest might register at a front door (creating a new identity pack); their identity pack may be immediately propagated to other nodes, etc.

Once the physical access resolution device has obtained system-wide flows, identity packs, and/or contextual information (if any), the physical access resolution device can begin access resolution operation. During access resolution operation, the physical access resolution device monitors for events according to its permitted flows (step 844). Access resolution based on situational awareness is described in greater detail within U.S. patent application Ser. No. 19/171,017 filed Apr. 4, 2025, and entitled “SYSTEMS, APPARATUS, AND METHODS FOR ACCESS RESOLUTION BASED ON SITUATIONAL AWARENESS”, previously incorporated herein by reference in its entirety. Importantly, unlike existing solutions that are focused on a single factor/multi-factor authentication and binary outcomes (grant/deny), the physical access resolution system assesses the entire access event (not just identity) and may responsively launch multiple resolutions at points throughout the access event (not just a binary decision). Information collection may be staged and handled with varying levels of privacy protections. Access resolution may be implemented according to multi-modal and/or confidence-based metrics.

In one embodiment, when the physical access resolution device detects an access event (or pre-access event, post-access event, etc.), it implements one or more processing flows that is a sequence of expected conditions and associated reactions.

Here, an “access event” may be characterized by a person (or other entity e.g., drone, animal, etc.) attempting access to a physical space (zone) via a physical threshold. Events prior to the access event may be referred to as “pre-access events” and events after the access event may be referred to as “post-access events”. Conditions refer to information that may be evaluated to identify and distinguish between different e.g., pre-access events, access events, post-access events. For example, a sensor may detect a person approaching a house, putting on shoes and coat, etc. Depending on the detected conditions, the pre-access event may be routine, anomalous, etc.

Access events may be processed in distinct stages. Separating processing into different stages enables abstraction, obfuscation, and/or other processing methodologies. In one specific implementation, the physical access resolution device may obtain information about the access conditions in stages, with multiple sensors, etc. More generally, increasing access condition information leading-up-to, during, and following-after the access event (pre-access, access, and post-access) may be leveraged for a variety of different situational awareness applications.

In one embodiment, the physical access resolution device senses data to determine the access condition. In one specific implementation, sensors may be staged as the access condition escalates toward an increasingly likely access event. For example, pre-access activity may be used to identify a number of subjects, classify a type of subjects, determine their speed and/or velocity (direction and magnitude), and/or other data collection and processing tasks in preparation of access attempts. The physical access resolution device proceeds to the next step when the likelihood of an access event exceeds a minimum confidence threshold.

In some embodiments, an array of different sensors may be used to collect multi-modal set of data regarding the access condition. Different sensor modalities may have different ranges, granularities, robustness, accuracy, and/or other predictive value. While any single sensor modality might be insufficient to determine/resolve an access event, their combined confidence may provide significantly higher confidence. Furthermore, confidence may also increase as predictive value accumulates (and decrease where predictive value is more erratic/conflicting). In one variant, confidence scores from one modality and/or stage may be statistically combined with other modalities and/or stages. Other implementations may use e.g., rule-based heuristics, machine learning, etc. As but one such example, an access condition may incorporate captured data from RF sensors, image sensors, microphones, etc.

In some embodiments, the sensed data may be captured across multiple zones and/or spaces. For example, an ingress and/or egress path may have multiple sensors with varying ranges of sensitivity and confidence. As another example, sensors may be located in different zones (exterior zone and interior zone). For example, exterior sensors may capture the approach of a person, while interior sensors monitor the occupants.

Certain access conditions may trigger additional processing and/or data collection. In some cases, the access conditions may incorporate e.g., system state. For example, the presence or absence of an occupant or a pet may affect the interpretation of a person coming to a door. Similarly, a person that takes a direct path to the front door may be viewed differently than a subject that appears to approach an open window or a garage that is open, etc.

In some variants, sensed data may be stitched together from different sensors to provide situational awareness. As but one such example, interior video may be stitched with exterior video to create a 360° video of the access event. As a similar example, audio tracks from the interior and exterior may be stitched together to generate a record of “dialog” or conversation spoken through a door. Still other variants may overlay e.g., visual information with infrared information, etc. Any technique for combinations, hybrids, and/or augmentations of different modalities of data may be substituted with equal success.

In other embodiments, data regarding an access condition may be received from another entity (e.g., a system administrator, a user device, a remote sensor, etc.). As but one such example, a person may call a user; the user may then approve the person. In some cases, the approval may be subject to certain access constraints (e.g., zone limitations, time duration, etc.). Additional constraints may be set by the user, so that the user does not need to actively monitor the access event and/or post-access. Still other access conditions may be scheduled, tracked, or triggered by other events (e.g., time of day, user input, location information, etc.). For example, a user may schedule a block of time for package delivery/in-home repair, etc. Here, the system may predict the corresponding access event, based on package tracking information, location tracking/estimated time of arrival, and/or local external information.

Once detected, the physical access resolution device assesses the situation. While various discussions throughout are presented in the context of specific examples, the concepts may be broadly extended to any situational assessment. Here, a situation refers to the set of conditions and/or events relevant to an access. Examples of relevant conditions and/or events may broadly include the physical environment, timing, resources, etc. In addition, the physical access resolution device considers the identity, actions, behaviors, and/or inferred intention of the entity(s) performing the access (e.g., person, people, animal(s), drone(s)/robot(s), etc.)

In one embodiment, the physical access resolution device uses a multi-modal assessment to identify a subject. In some embodiments, the subject explicitly provides an identity which is authenticated, validated, and/or verified by the physical access resolution device. Here, validation and its linguistic derivatives refers to processes that confirm that data is valid, whereas verification and its linguistic derivatives refers to processes that confirm that data is true. Validity and truth are distinct; e.g. a digitally signed certificate may be checked for validity against the signer's certificate-however, if the signer was compromised, then the signed data may still be malicious. Conceptually, an identity may be authenticated to varying degrees based on validation and/or verification of data. For example, a person may be explicitly authenticated by verifying a password challenge (binary, “hard” information), a person may also be implicitly authenticated to varying degrees of confidence by validating multiple layers of soft information (non-binary).

In some embodiments, assessment is performed according to a multi-layered assessment. In other words, a first level of confidence may trigger a first resolution, a second level of confidence may trigger a second resolution, etc. Thus, a very confident assessment may grant access and quiesce, whereas a less confident assessment may grant access but continue to monitor post-access activity. In other words, soft information may be used to tailor reactions to according to the level of confidence.

As discussed elsewhere, various embodiments of the present disclosure use statistical analysis and/or confidence metrics to assess soft information. More generally however, soft information may correspond to any gradation of assessment. In other words, while the various concepts are based on confidence-based identification, the concepts may be broadly extended to other forms of soft identification and/or confidence-based resolutions. For example, machine-learning techniques and/or heuristics may be substituted for identification with equal success.

More generally, situational awareness refers to any soft information that is inferred from explicitly known (hard) information associated with an access event. Explicitly known information is directly measured, sensed, captured, logically derived, or otherwise factually exists. Inferred information is assumed to have some probability of being accurate (and a corresponding probability of inaccuracy). Inferred information may be extrapolated, interpolated, learned from, and/or predicted based on explicitly known information.

During flow processing (steps 846 and 848), the physical access resolution device obtains the steps of a flow, then iteratively detects when a condition has been met and performs its associated reactions, then transitions to the next set of conditions and reactions. In one specific implementation, conditions and reactions are embodied as a state machine which uses event-based triggering to transition between states. Each state may have a new set of conditions and reactions.

In one specific implementation, the flow processing incorporates system-wide information to ensure that the physical access resolution device coordinates with its peers and/or implements its behaviors consistent with other system-wide considerations. Compared to conventional smart locks that typically only consider local information in determining whether to lock/unlock, the physical access resolution devices of the present disclosure may implement multiple different flows based on system-wide information to handle a variety of different usage scenarios. For example, a context-based door might consider whether the residence is in a secure state (all doors locked and unoccupied), unsecure state (at least one door unlocked and unoccupied), private state (all doors locked and at least one occupant) or public state (at least one door unlocked and at least one occupant present). A person that approaches a locked door (local context) while the residence is in an unsecure state might trigger a defense response e.g., alarms, verbal notifications, lock actuation, and/or other defensive reactions. In contrast the same local context might cause a different response for a different system state (e.g., a public state might allow the door to unlock and audibly chime to notify the home owner of the visitor's arrival).

While the foregoing examples describe system state considerations, the flow processing may also incorporate information from other peer devices. In some cases, peer information may be provided to the physical access resolution system administration logic and distributed to nodes as-needed (e.g., a publish-subscribe (pub-sub) protocol). In other cases, peer information may be directly provided (e.g., using ad hoc communication protocols such as Bluetooth, etc.). Pub-sub protocols are helpful for moderated access, whereas direct peer-to-peer communication may be useful for mesh network style communications, common with home appliances and Internet of Things (IoT). Direct communications may also be helpful as a robust fallback option—e.g., where connectivity to the system administration logic is either unavailable or otherwise unresponsive.

As a practical matter, standalone operation and/or node coordination (even without centralized management of security protocols) may be desirable for certain system failures e.g., power outages, cyber attacks, etc. As one such example, a physical access resolution device for an interior door might communicate with a fire alarm, such that the interior door can automatically close to prevent fire spread and/or unlock to allow for evacuation. Here, the direct communication link does not rely on centralized communication which could be impacted. Various other ad hoc and/or decentralized communication scenarios may be substituted with equal success by artisans of ordinary skill given the contents of the present disclosure.

Peer devices may include other physical access resolution devices (e.g., context-based doors, smart doors, smart locks, etc.), a user's personal devices (e.g., phones, laptops, etc.), along with other household appliances (e.g., fire alarms, carbon monoxide detectors, radon detectors, washing machines, dishwashers, etc.).

Furthermore, these concepts may be further extended to broader network applications. In other words, additional services may be tied in directly to physical access resolution devices and/or via system administration APIs. Remote roll-out and/or administration of flow processes may be helpful for users that rent their residences to guests and/or manage their own family member usages (e.g., elderly assisted living, etc.).

While the foregoing discussion is presented in the context of a state machine implementation, any form of heuristic and/or decision logic may be substituted with equal success. Other examples of such heuristics may include e.g., artificial intelligence/machine learning, if-this-then-that (IFTTT) conditional logic, rules engines, etc.

### 3.2 Coordination and Administration

Functionally, the system administration logic 900 coordinates and oversees the operation of the physical access resolution devices 800. For example, some access events may be informed by multiple physical access resolution devices (e.g., a secured residence means that all entrances are individually secured, a user may enter and exit at different thresholds, etc.). In other words, system-wide administration improves situational awareness.

System administration may be performed at a local networked resource, or virtualized and handled via cloud compute resources. Cloud services refer to software services that can be provided from remote data centers. Typically, cloud compute datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

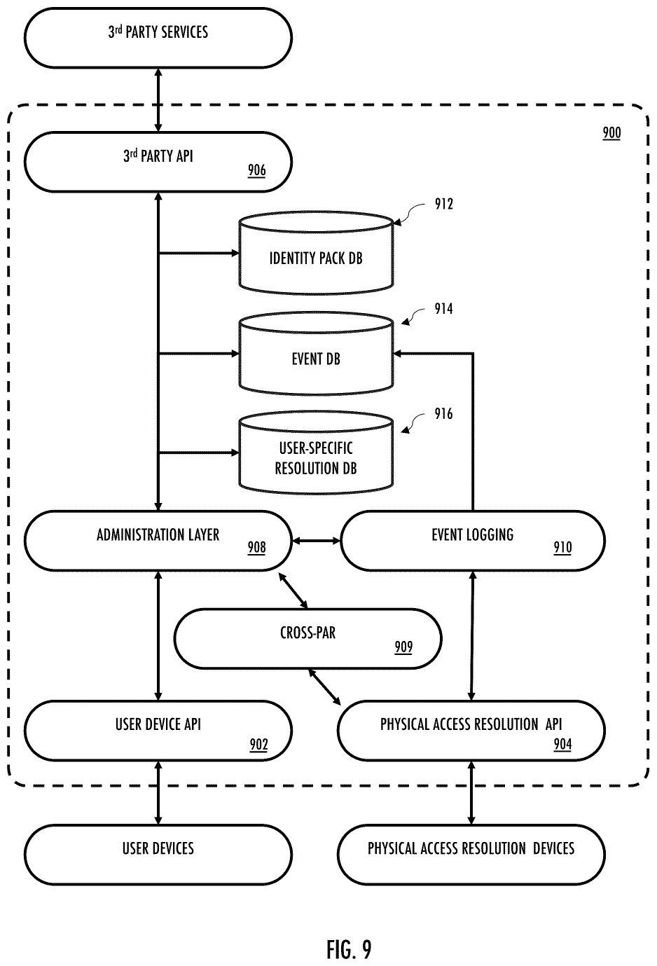

Here, the system administration logic 900 is subdivided into constituent services, rather than their physical implementation (which could be localized or cloud-based). FIG. 9 is a logical block diagram of the system administration logic 900. The system administration logic 900 includes: one or more application programming interfaces (APIs) (e.g., user device API 902, physical access resolution device API 904, and 3^{rd} party API 906), an administration layer 908, event logging 910, and one or more storages (e.g., identity pack database 912, event database 914, and resolution database 916, etc.). In some variants, the system administration logic 900 may additionally include cross-PAR communication logic 909.

Other system implementations may multiply, combine, further subdivide, augment, and/or subsume the foregoing functionalities within these or other logical nodes. For example, event logging may be locally stored at physical access resolution devices and/or archived within external cloud resources. Similarly, administration layer functionality may be handled in part, or whole, at other nodes of the system (e.g., user devices, physical access resolution devices, etc.).

An API (Application Programming Interface) is a set of rules and protocols that allows different software applications to communicate and interact with each other. It defines the methods, data formats, and conventions that enable access to, and functionality of, a software service, library, or platform. The illustrated implementation includes APIs to interact with the other components of the system. The user device API 902 enables communication with user devices (e.g., smart phones, laptops, etc.), the physical access resolution device API 904 monitors and controls the physical access resolution device operations, and 3^{rd} party API 906 may be used to further extend system functionality.

Conventional internet access APIs may be based on a server endpoint that supports one or more client endpoints. Generally, the server endpoint has a URL (which translates to an IP address) to send and receive requests and responses. Clients send and receive using HTTP methods e.g., GET, POST, PUT, DELETE. The responses are usually provided in computer-parsed formats (e.g., JSON, XML, etc.). The server and client endpoints may additionally support authentication and authorization, rate limiting, and error handling protocols. Artisans of ordinary skill in the related arts will readily appreciate that the server and client may coordinate via complementary function calls to implement very sophisticated logical interactions over the underlying API framework.

A storage is configured to structure and collect data in a manner that allows efficient storage, retrieval, and manipulation of information. Here, the illustrated implementation includes e.g. identity pack database 912, event database 914, and resolution database 916, etc.

The storage organizes data according to any number of relational schemas. Common examples of such schemas may associate data according to user, modality, time, location, metadata (extracted features, etc.). Queries may be made against the database, according to authorizations and/or other access control restrictions. For example, a user may query the database for their own data at a first level of access (unrestricted) but may have a reduced second level of access to other user's data. Other databases may be substituted with equal success. In some embodiments, the storage may be accessible via one or more of the APIs (with appropriate permissions, etc.).

The following discussions explore various aspects of the system administration logic 900 in greater detail.

Event logging functionality records information about the access events, user actions, and other significant activities that occur within the system. Event logging may track e.g., timestamp, access event type, physical access resolution device, resolution(s), troubleshooting codes, confidence information (false positive, false negative, true positive, true negative, etc.), and/or associated data (e.g., images, audio, etc.)

In some embodiments, cross-PAR communication logic 909 enables physical access resolution devices to directly communicate with one another. In other embodiments, the system administrator logic may allow physical access resolution device to broadcast, multicast, or unicast their events to other entities. In some cases, this system feed may additionally enable user devices and/or 3^{rd} party applications to e.g., subscribe to network traffic and/or define and effectuate other events, resolutions, etc.

In one specific embodiment, the cross-PAR communication logic 909 may allow for abstraction and integration across layers. For example, sensor layer communications may communicate across peer devices at the sensor layer, assessment layer communications may communicate across peer devices at the assessment layer, etc. Thus, an assessment layer of one physical access resolution device may use sensor information from a different physical access resolution device, according to the abstraction schemes described elsewhere. For example, a physical access resolution device at an exterior door may assess its local situation (access event) based on data from other physical access resolution devices (to determine occupancy). In other words, abstraction allows each layer to integrate system-wide information from other devices.

The identity pack database stores data that may be used to validate, verify, and/or authenticate an individual, either directly or indirectly when combined with other data. Each identity pack may include e.g., biometric data (e.g., voice print, face print, finger print, gait, etc.), electronic and/or RF signatures (e.g., SIM ID, IMSI, etc.), behavioral data (e.g., personal habits, routines, schedule, etc.), explicit challenges (e.g., passcodes, PIN, etc.).

The event database stores event logging information, which may incorporate e.g., timestamp, access event type, physical access resolution device, resolution(s), troubleshooting codes, confidence information (false positive, false negative, true positive, true negative, etc.), and/or associated data (e.g., images, audio, etc.).

Resolution database stores a mapping of access events (pre-access events, post-access events, etc.), conditions, and their corresponding resolutions. Anecdotally, the number of different permutations that could be possible is likely too large for an administrator to conveniently wade through, thus the resolution database may be continuously updated with new mappings learned behaviors, according to administrator preferences, audit, and/or approval (such as may be collected from a user device, etc.).

As previously alluded to, individual physical access resolution devices will cache information from the storages (e.g., identity pack database 912, event database 914, and resolution database 916, etc.), to ensure that they can operate in “standalone” mode. Nonetheless, the shared storages may be used to synchronize behavior of the devices. Furthermore, shared information may also be used to synchronize newly added devices to system state. Finally, certain types of information may require system-wide distribution; e.g., a “lockdown” may cause all physical access resolution devices to “lock” in anticipation of an imminent threat, similarly a “fire alarm” may cause all physical access resolution devices to “unlock” but also close doors (to slow the spread of fire), etc.

The administration layer 908 manages and controls the configuration, users, policies, and overall operation of the system, and its component physical access resolution devices. The administration layer may be accessible via a user device, management portal, cloud service, and/or administrator interface.

Administration functionality may include, without limitation, user management, access control, system configuration, physical access resolution device configuration, user device access, etc. User management generally refers to the addition, modification, and removal of members. User management may additionally allow an administrator to define non-member handling, and/or other behavior (e.g., emergency behavior, etc.). Access control may define associated roles, privileges, restrictions, etc. for members and non-members; access control may include both physical and/or logical accesses. Configuration may include configuration of zones, times, access events, access conditions, and/or any other system or premises behavior. In some cases, this may additionally include configuration of individual physical access resolution devices and/or user devices. Various other administration-based functionality may be included, subsumed, augmented, and/or divided from this layer by artisans of ordinary skill in the related arts, given the contents of the present disclosure.

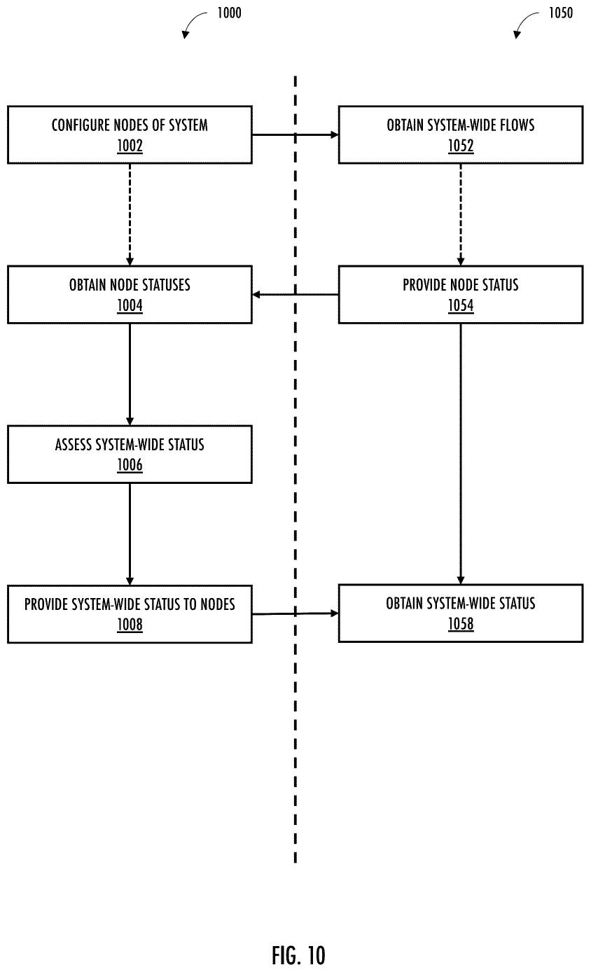

FIG. 10 is a logical block diagram illustrating information distribution within the physical access resolution system. In one specific implementation, system information is collected, assessed, and/or distributed by the administration layer 908 to a network of nodes (e.g., physical access resolution devices) via the physical access resolution API 904. These logical steps may be embodied within hardware as circuitry, software as non-transitory computer-readable instructions, and/or hybrids thereof (firmware, etc.).

At step 1002 of the method 1000, the administration layer may configure the nodes of the system with a set of flows. The nodes may be configured with a default set of flows based on a node's functionality, capability, and/or responsibility. Node functionality, capability, and/or responsibility may be e.g., discovered during device initialization and/or enumeration, set by the user, inferred based on usage, emerge via firmware updates and/or other devices are added to the system (e.g., emergent properties of networks, etc.). For example, nodes that have limited sensor modalities may have simpler, but more stringent, authentication flows; nodes that have more capable sensors may allow for more permissive authentication flows. Nodes that have 360° capability may support flows that span pre-access, access, and/or post-access—nodes that have only 180° capability may only support pre-access/access or access/post-access flows, etc. As noted elsewhere, different nodes of the system may have different functionalities, capabilities, and/or responsibilities within the residence. For example, primary entrances may be used for visitors, deliveries, etc.; the system administration layer may assign delivery and/or visitor flows to these doors. Side doors and/or back doors may be more commonly used by residents for specific purposes (e.g., maintenance access, vehicle access, pets, etc.)—these may have usage-specific flows. In other words, the administration layer may tailor the behaviors of each node to their intended use.

In addition to default flows, the administration layer may additionally provide user-defined flows. User-defined flows may be set by a user and/or accumulated over time based on patterns of usage, etc. For example, a user that purchases and installs an aftermarket context-based lock kit may import their flows. Similarly, a user that moves into a new apartment may bring their flows from their previous apartment. A guest that is using a short term rental may duplicate their flows and/or identity pack data structures from their home account. Various other schemes for adding, removing, and/or modifying user-defined flows may be readily substituted with equal success.

During normal operation, the administration layer may obtain node statuses (step 1004). Node status may be event-driven, periodically reported, and/or requested as-needed. Node status may include its state, event, and/or contextual information; additional metadata may include e.g., timestamps, sensor data (e.g., images, audio, video, IMU data, etc.), derived data (e.g., confidence levels, faceprints, voice prints, etc.), and/or operational data (e.g., processor usage, memory usage, remaining battery life, etc.).

At step 1006, the collected node status and/or metadata may be used by the administration layer to infer and/or further investigate the system-wide effects of a pre-access, access, and/or post-access events. Various aspects of the present disclosure use node status and/or metadata to infer e.g., occupancy, identity, zones of activity, activity type, intent, and/or likely future behavior. While various discussions throughout are presented in the context of specific examples, the concepts may be broadly extended to any system-wide assessment.

As noted elsewhere, confidence-based node assessments may be treated as “soft” information. Conceptually, a 75% confidence in identification leaves a 25% uncertainty in identification at the node. Thus, from a system-wide standpoint, node-specific information may need to be augmented and/or investigated further. In some variants, the administration layer may request more information from other nodes and/or further combine their results to refine confidence. Lower confidence situations may trigger low confidence system-wide states that perform more frequent and/or invasive monitoring; high confidence situations may be more permissive.

Various embodiments of the present disclosure may use statistical analysis and/or confidence metrics to assess soft information. Soft information may correspond to any gradation of assessment. In other words, while the various concepts are based on confidence-based node status and/or metadata, the concepts may be broadly extended to other forms of soft information. For example, machine-learning techniques and/or heuristics may be substituted for identification with equal success. Other techniques may include extrapolation, interpolation, pattern matching, and/or prediction-based assessments.

While the foregoing discussion is presented in the context of a state machine implementation, any form of heuristic and/or decision logic may be substituted with equal success. Other examples of such heuristics may include e.g., artificial intelligence/machine learning, if-this-then-that (IFTTT) conditional logic, rules engines, etc.

At step 1008, the system-wide state is provided to the impacted nodes. System-wide states (e.g., secured, unsecured, private, public, delivery, lockdown, etc.) may be important for node behaviors. As discussed elsewhere, the absence/presence of the home owner may change the relevant flows at a node (e.g., approaching persons may be announced rather than authenticated, etc.). As another example, a delivery state might be important for an exterior node to context unlock, and an interior node to handle post-access monitoring. More generally, system-wide state information may be used by nodes to coordinate their behaviors.

Referring now to the corresponding method 1050 implemented at the nodes, each node may obtain a set of flows from the administration layer (step 1052). In some embodiments, the received flows may be added to any flows that the node natively supports (e.g., basic functionality may be implemented by default). In other embodiments, the node may be permitted (and/or denied) flows based on functionality, capability, and/or responsibility. As a practical matter, various manufacturers may implement features differently; the administration layer may want to ensure consistency and/or a known level of operation.

During normal operation, the node may provide its status and/or associated metadata and the node obtains system-wide state updates (step 1054 and step 1058). The system-wide state information may be used to adjust its operational behavior as discussed elsewhere.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for situationally aware access, comprising:
determining a first access event based on a classification of a person approaching a first zone associated with a physical threshold;
where the first access event is determined from a plurality of access events associated with a plurality of conditions and a plurality of reactions;
determining a first condition and a first reaction based on the first access event; and
in response to the first condition, executing the first reaction.

2. The method of claim 1, where the classification of the person is selected from members and non-members.

3. The method of claim 2, where the members are authorized for a first set of access events characterized by a first set of conditions and a first set of reactions and where the non-members are authorized for a second set of access events characterized by a second set of conditions and a second set of reactions.

4. The method of claim 2, where the classification of the person is based on an identification process comprising at least one of a biometric challenge, a cryptographic challenge, or a device challenge.

5. The method of claim 1, where the first access event is an exit event, the first zone comprises an interior security zone, where the physical threshold is further associated with an exterior security zone, the first condition comprises the person moving a first distance within the exterior security zone, and the first reaction comprises context-locking the physical threshold.

6. The method of claim 1, where the first access event is an entry event, the first zone comprises an exterior security zone, where the physical threshold is further associated with an interior security zone, the first condition comprises the person moving a first distance within the interior security zone, and the first reaction comprises context-locking the physical threshold.

7. The method of claim 1, further comprising determining a second condition and a second reaction based on the first access event, and in response to the second condition, executing the second reaction.

8. The method of claim 7, where the first condition is a routine condition, the second condition is an anomalous condition, and where the second reaction comprises logging an anomalous event within a data structure.

9. The method of claim 7, where the first condition is a routine condition, the second condition is an urgent condition, and where the second reaction comprises requesting a security response by a security service.

10. A method for situationally aware building access control, comprising:
associating a plurality of physical thresholds with a building, where each physical threshold of the plurality of physical thresholds has a set of possible threshold states;
monitoring the plurality of physical thresholds to determine a plurality of real-time threshold states; and
determining a building state based on the plurality of real-time threshold states.

11. The method of claim 10, where each physical threshold of the plurality of physical thresholds is associated with a set of access events characterized by a set of conditions and a set of reactions.

12. The method of claim 11, where a first physical threshold is associated with an access event characterized by a first condition that causes a first reaction which affects at least a second physical threshold other than the first physical threshold.

13. The method of claim 11, where at least one physical threshold is associated with an exit event, where a first condition comprises a person moving a first distance beyond an exterior security zone, and a first reaction comprises context-locking the at least one physical threshold.

14. The method of claim 10, where the set of possible threshold states comprises at least a locked state, a propped open state, and an unlocked state.

15. The method of claim 13, where the building state is determined from a group of states comprising a secure state and an unsecure state.

16. A physical threshold configured to control access between a first zone and a second zone, comprising:
at least one sensor configured to monitor the first zone and the second zone;
a positional sensor configured to measure a position of the physical threshold;
a processor; and
a non-transitory computer-readable medium comprising instructions, which when executed by the processor, cause the physical threshold to:
monitor the first zone and the second zone based on a first state;
execute a first reaction based on first conditions for the first state and transition to a second state;
monitor the first zone and the second zone based on the second state;
execute a second reaction based on second conditions for the second state and transition to a third state;
monitor the first zone and the second zone based on the third state; and
execute a third reaction based on third conditions for the third state.

17. The physical threshold of claim 16, where the at least one sensor comprises two hemispherical cameras configured to capture images and the instructions further cause the processor to stitch the images into a 360° field-of-view.

18. The physical threshold of claim 17, where the first zone comprises an interior security zone, the second zone comprises an exterior security zone, and the 360° field-of-view is oriented relative to the interior security zone and the exterior security zone based on the position of the physical threshold.

19. The physical threshold of claim 18, further comprising a lock mechanism configured to secure the physical threshold in a locked position, and where the second reaction actuates the lock mechanism.

20. The physical threshold of claim 18, further comprising a network interface, and where the third reaction transmits an urgent notification or anomalous notification.
